(19) United States
(12) Patent Application Publication
(10) Pub. No.: US 2013/0059741 A1
(43) Pub. Date: Mar. 7, 2013

(54) BINDING ASSAYS FOR MARKERS

(71) Applicant: Michael P. Weiner, Guilford, CT (US)

(72) Inventor: Michael P. Weiner, Guilford, CT (US)

(73) Assignee: ILLUMINA, INC., San Diego, CA (US)

(21) Appl. No.: 13/696,848

(22) PCT Filed: May 13, 2011
(86) PCT No.: PCT/US11/36472

§ 371 Date: Nov. 8, 2012

Related U.S. Application Data
(60) Provisional application No. 61/334,252, filed on May 13, 2010.

(51) Int. Cl. C40B 20/04; C40B 40/06

(52) U.S. Cl. 506/4; 506/16

(57) ABSTRACT

This invention provides compositions and methods for assaying the presence of a target analyte in a sample using a solid support. Embodiments of the present invention provide a solid support having a binding protein, such as an antibody, antibody fragment or protein receptor, immobilized to the solid support and at least two separate nucleic acid primers immobilized near the binding protein. This invention also provides a method for tethering two or more polypeptide subunits to generate a multifunctional fusion protein, which can have a primary function, e.g., binding a target analyte, such as a target protein, or an enzymatic activity, and one or more of the subunits of the fusion protein carries out a secondary function, e.g., capture on a solid matrix or quantitation.

This application is a National Stage Entry of PCT Application Serial No. PCT/US2011/36472, filed May 13, 2011, which claims priority to U.S. Provisional Application Ser. No. 61/334,252, filed May 13, 2010, the entire contents of both are incorporated herein by reference in their entireties.

### BACKGROUND OF THE INVENTION

The present invention relates generally to compositions and methods for determining the presence or absence of target analytes in a sample, and more specifically to using solid supports having a combination of binding proteins and nucleic acids for identifying target analytes present in a sample. The present invention also relates to the area of recombinant fusion proteins in which two or more functional domains are the tethered to each other in order to generate a multifunctional protein, the means of such generation and the uses of such fusion proteins.

Sensitive protein detection assays are becoming increasingly desirable due to recent advances in proteomics and the importance of protein diagnostics for disease monitoring. The sensitivity of protein assays is often dependent on the technician's ability to separate the desired protein from other contaminating particles and the ability to minimize background noise, which, when too high, results in less than desirable signal strength. Traditional assays such as a sandwich enzyme linked immunosorbant assays, i.e. sandwich ELISA, rely upon immobilizing an antigen specific capture antibody to a solid surface, which then binds to the target antigen. After the antigen is immobilized, the detection antibody is added, forming a complex with the antigen. The detection antibody is conjugated to an enzyme, which produces a visible signal when it is contacted with the appropriate enzyme substrate. Alternatively, in some assays, the detection antibody itself is detected by a secondary antibody that is linked to the enzyme for producing the visible signal. This type of assay requires several washes to decrease the background noise, but this washing also results in reduced signal strength.

Moreover, traditional ELISA assays involve chromogenic reporters and substrates that produce some kind of observable color change to indicate the presence of the antigen. Some resent ELISA-like techniques utilize fluorogenic, electrochemiluminescent, and real-time PCR reporters, which have been shown to create quantifiable signals that are often highly sensitive and capable of being multiplexed. However, many of these ELISA-like techniques still do not lend themselves to ultra-high throughput assays using an array. For example, Immuno-PCR, which utilizes a second antibody that recognizes the immobilized target antigen and is conjugated with a report oligonucleotide, still requires that the report oligonucleotide be amplified using polymerase chain reaction (PCR) in a vessel, microwell or container that does not allow cross contamination from other nearby reactions. Thus, there exists a need for a method of detecting a target protein that is highly sensitive, capable of being multiplexed and appropriate for ultra-high throughput analysis. The present invention satisfies this need and provides related advantages as well.

### SUMMARY OF INVENTION

This invention provides compositions and methods for assaying the presence of a target analyte in a sample using a solid support. Embodiments of the present invention provide a solid support having a binding protein, such as an antibody, antibody fragment or protein receptor, immobilized to the solid support and at least two separate nucleic acid primers immobilized near the binding protein. Additionally, the invention provide a solid support wherein a binding complex is formed between the binding protein immobilized to the solid support, a target analyte and a second binding protein. The invention still further provide a solid support wherein such a binding complex further forms a hybridization complex between one nucleic acid primer immobilized on the solid support and an oligonucleotide tag linked to the second binding protein. In some aspects, the invention also provides an array that in includes a plurality of these solid supports.

The invention further provides that such solid supports can be used in a method for detecting numerous target analytes. In one embodiment of the present invention, the method for detecting a target analyte includes providing a solid support having a binding protein immobilized to the solid support and a second binding protein provided in solution, wherein the first binding protein recognizes and is capable of binding a target analyte in the presence of the second binding protein, which also recognizes and binds the same target analyte, contacting the solid support with target analyte and the second binding protein under sufficient conditions to allow formation of a binding complex between the target analyte and both the first and second binding proteins, hybridizing the oligonucleotide tag linked to the second binding protein to a first nucleic acid primer immobilized on the solid support, extending this first primer whereby a complement of the oligonucleotide tag is generated, amplifying the newly generated complement using a second nucleic acid primer immobilized to the solid support and detecting the presence of the amplicon, wherein the presence of the amplicon indicates the presence of the target analyte. Moreover, the invention also provides a method for detecting a target analyte, wherein the method described above alternatively proceeds following the extension step by hybridizing the complement of the oligonucleotide tag that is generated, to a second nucleic acid primer immobilized on the solid support forming a second hybridization complex, then extending the second nucleic acid primer with at least one labeled nucleic acid residue, using methods such as single base extension or sequencing by synthesis, wherein the nucleic acid residue added to the primer is dependent on the nucleic acid sequence of the oligonucleotide tag, followed by detecting the presence of the labeled nucleic acid residue on the solid surface, wherein the presence of the labeled nucleic acid residue indicates the presence of the target analyte.

Embodiments of the invention also provide a multiplex method for detecting a plurality of target analytes in a sample by providing a plurality of solid supports, such as beads, wherein each solid support independently includes a first binding protein and at least two nucleic acid primers immobilized to the solid support, wherein the first binding protein recognizes and binds a unique target analyte, providing a plurality of second binding proteins, wherein each of the second binding proteins are linked to a distinguishable oligonucleotide tag having a first and second region, and wherein each binding protein is capable of recognizing and binding one of the same target analytes at the same time as the first binding protein, contacting the plurality of solid supports with a sample having a plurality of unique target analytes in the presence of the plurality of second binding proteins under sufficient conditions to form binding complexes between the unique target analytes and first and second binding proteins, hybridizing the first region of the oligonucleotide tag linked to the second binding protein to the first nucleic acid thereby forming a hybridization complex for each of the plurality of solid supports, extending this first primer whereby a complement of the oligonucleotide tag is generated for each of the plurality of solid supports, amplifying the newly generated complement using the second nucleic acid primer for each of the solid supports and detecting the presence of the amplicon for each of the solid supports, wherein the presence of the amplicon at an individual solid support indicates the presence of the unique target analyte in the sample. Moreover, the invention also provides a method for detecting a plurality of target analytes, wherein the method described above alternatively proceeds following the extension step by hybridizing the complement of the oligonucleotide tag that is generated to the second nucleic acid primer immobilized on the solid support by the second region in the tag forming a second hybridization complex for each of the solid supports, then extending the second nucleic acid primer with at least one labeled nucleic acid residue for each of the solid supports, using methods such as single base extension or sequencing by synthesis, wherein the nucleic acid residue added to the primer is dependent on the nucleic acid sequence of the oligonucleotide tag, followed by detecting the presence of the labeled nucleic acid residue on each of the solid supports, wherein the presence of the labeled nucleic acid residue indicates the presence of the unique target analyte in the sample.

This invention also provides a method for tethering two or more polypeptide subunits to generate a multifunctional fusion protein. In one enablement, one or more of the subunits of the fusion protein carries out a primary function, e.g., binding a target analyte, such as a target protein, or enzymatic activity, and one or more of the subunits of the fusion protein carries out a secondary function, e.g., capture on a solid matrix or quantitation. In a second enablement the subunits of the fusion protein carry out a single function jointly, e.g., capture of a molecule by a binding domain on one subunit and alteration of the molecule by a catalytic domain on a second subunit. In one aspect, these fusion proteins are combined, forming a complex to achieve or optimize a primary function, e.g., tighter and/or more specific binding of a target molecule or improved enzyme efficiency. Similarly, these fusion proteins are optionally complexed to achieve, optimize and/or combine secondary functions, e.g., capture of a complex on a solid matrix and quantitation of the amount of complex bound. Alternatively, these fusion proteins are optionally complexed to achieve, optimize and/or combine a single function jointly, e.g., establishment of a linked metabolic pathway involving a plurality of enzymatic steps for efficient conversion of a starting substrate to a desired metabolic product.

### BRIEF DESCRIPTION OF THE DRAWINGS

FIG. 1 shows a schematic illustration of the reaction components for assaying a single target protein having two epitopes, A and B, using scFV antibody fragments. Depicted herein is a single bead having an antibody fragment (scFvA) attached thereto, which recognizes and binds the a-epitope A of the target protein. The single bead also includes two separate DNA strands, which include either a tag B′ or tag A′ sequence. Another reaction component is a second antibody fragment (scFvB) attached to a DNA oligonucleotide tag in solution. ScFvB recognizes and binds the α-epitope B of the target protein. The DNA tag includes a ZipCode sequence which contains information on the target protein, a first nucleic acid sequence that is complementary to B′ and a second nucleic acid sequence that is complementary to A′. The first and second nucleic acid sequences will be used to generate DNA clusters of A+B on the bead.

FIG. 2 shows a schematic illustration of reaction components shown in FIG. 1 forming a sandwich complex. A sandwich complex is formed between the two antibody fragments and the target protein. Specifically, scFvA binds a-epitope A and scFvB bind α-epitope B. Moreover, upon formation of the sandwich complex, hybridization of the DNA tag forms a hybridization complex between the DNA tag and the bead-coupled DNA tag B′ sequence.

FIG. 3 shows a schematic illustration of transferring of the ZipCode and A′ complementary sequence present in the oligonucleotide tag to a bead using DNA polymerase and dNTPs added to the reaction. Alternatively, DNA ligase in conjunction with appropriate complementary DNA segments could also be used to transfer the ZipCode and A′ complementary sequence to the bead.

FIG. 4 shows a schematic illustration of the steps involved in generating A+B clusters using the scFv-proximal A′ complementarity as depicted in FIGS. 1-3. Step A shows the initial sandwich complex formed between the two antibody fragments and the target protein, wherein the oligonucleotide tag includes an A′ complementary sequence of TTTT and a B′ complementary sequence of CCCC. Step B shows the hybridization of the B′ GGGG sequence to the CCCC sequence of the oligonucleotide tag. Step C shows the extension of the B′ nucleic acid sequence making a complement of the oligonucleotide tag. Step D shows the removal of the sandwich complex and the initial hybridization complex and the formation of a second hybridization complex between the A′ TTTT sequence and the A′ complement sequence of AAAA. Steps E through G shows the bridge amplification of the oligonucleotide tag using DNA A′ and B′ primers immobilized on the bead which form DNA oligonucleotide clusters on the bead.

FIG. 5 shows a schematic illustration of the components that can be used to generate a multiplex binding protein assay. The exemplified strategy shown illustrates how three unique antigens can be detected. Antigen 1 is detected using scFv1 and scFv2 and immobilized primers A′ and B′ on bead type 1. Antigen 2 is detected using scFv3 and scFv4 and immobilized primers C′ and D′ on bead type 2. Antigen 3 is detected using scFv5 and scFv6 and immobilized primers E′ and F′ on bead type 3. As disclosed herein, this multiplex assay can be significantly scaled up to accommodate detecting numerous target antigens or analytes.

FIG. 6 shows a schematic illustration of the multiplex binding protein assay depicted in FIG. 5 using a bead array. The presence of the numerous target antigens or analytes in a sample can be assayed using the bead array, which can be decoded by DNA sequencing or other methods as disclosed herein.

FIGS. 7A and 7B shows a schematic illustration of a method for detecting a target analyte using a binding protein assay followed by detection by single base extension or sequencing by synthesis. Step A shows the reaction components for assaying a single target analyte having two epitopes, which are depicted as a triangle and a half circle. The first antibody fragment (1), primer B′ and primer A are immobilized to a solid surface. A second antibody fragment (2) is provided, which is linked to an oligonucleotide tag having regions A and B. Step B is the initial binding complex formed between the two antibody fragments and the target protein, which is followed by region B the oligonucleotide tag hybridizing to the B′ primer immobilized on the solid support. Step C shows removal of the target analyte and the extension of the B′ primer making a complement of the oligonucleotide tag. Step D shows the removal of the initial hybridization complex leaving only the newly generated complement of the oligonucleotide tag. Step E shows the formation of a second hybridization complex between the A′ sequence of the oligonucleotide tag complement and the immobilized A primer. Step F shows the detection of the target analyte by the addition of a labeled nucleic acid to the hybridization complex formed in step E by single base extension or sequencing by synthesis.

### DETAILED DESCRIPTION OF THE INVENTION

This invention provides compositions and methods for assaying the presence of one or more target analytes in a sample using a solid support. These compositions and methods can be used in a variety of highly sensitive and ultra-high throughput assays for determining the composition of a sample by assaying for the presence of specific target analytes in the sample. For example, the compositions and methods disclosed herein can be used to determine the proteomic profile of a tissue biopsy sample, which can be used to identify and diagnose a patient with an associated disease or condition, such as cancer. Moreover, the compositions and methods disclosed herein are generally applicable to assaying for the presence of an important analyte in a variety of settings including clinical, industrial, agricultural and environmental. Embodiments of the invention disclosed herein are particularly applicable to being automated, but are also applicable to manual manipulation.

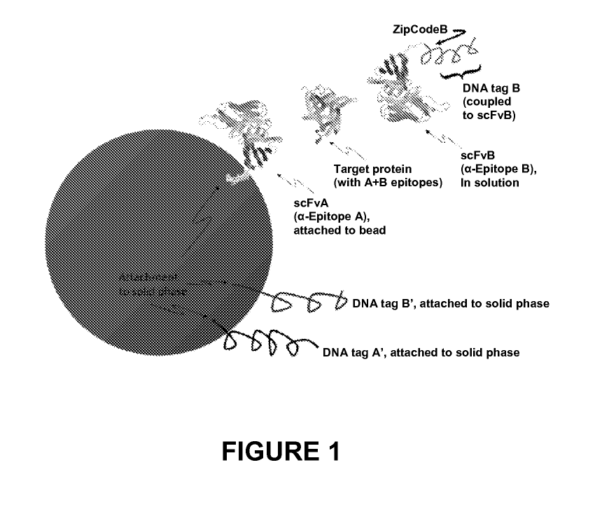

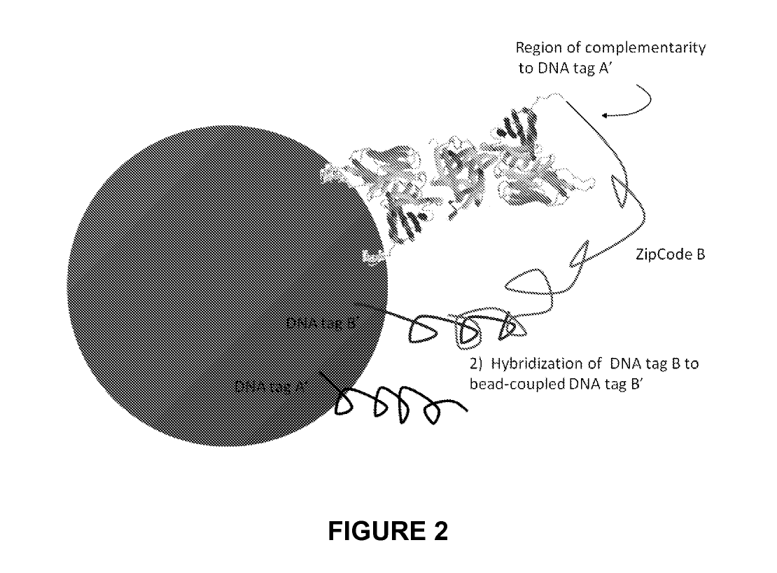

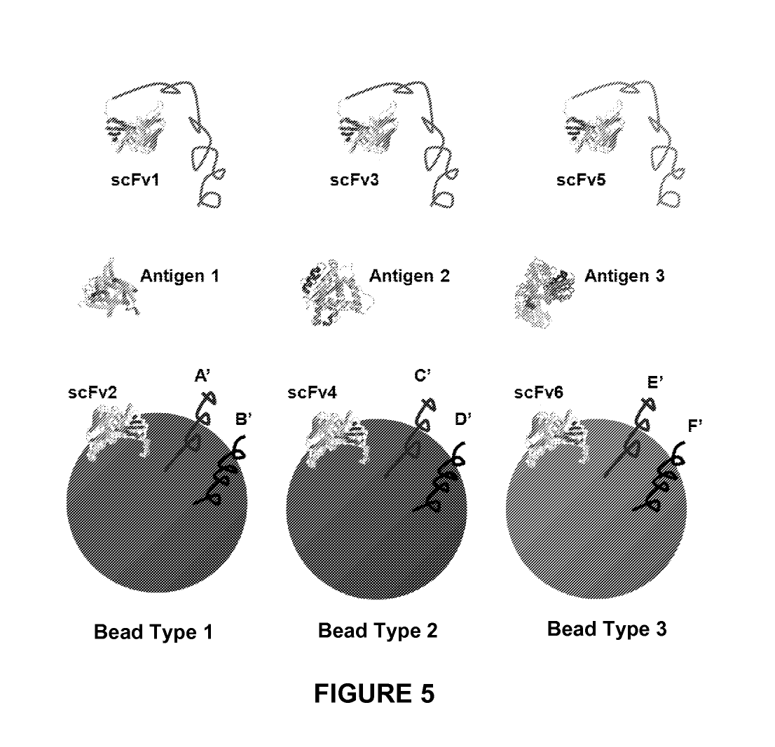

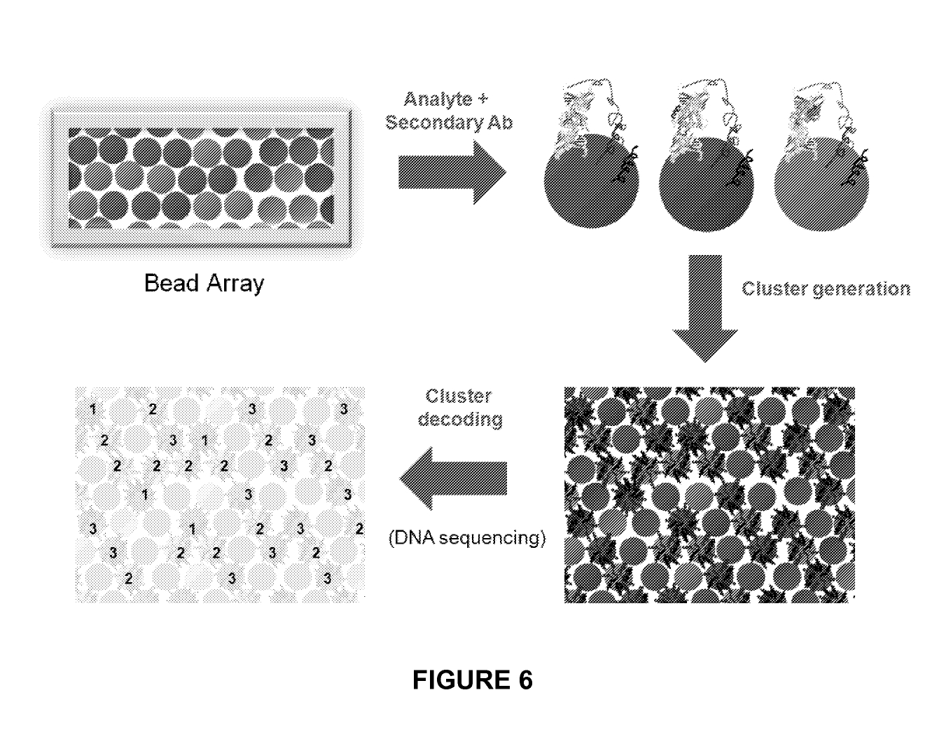

Accordingly, in some embodiments, the present invention provides a solid support having: a first binding protein, such as an antibody fragment, immobilized to a solid support, wherein the binding protein has a binding region specific for a first epitope of a unique target analyte; a second binding protein, such as an antibody fragment, linked or attached to a distinguishable oligonucleotide tag that includes a first and a second region, and a binding region specific for a second epitope of the unique target analyte, wherein the second epitope is distinguishable from the first epitope; a first nucleic acid primer immobilized to the solid support, wherein the first nucleic acid primer includes a nucleic acid sequence that is complementary to the first region of the oligonucleotide tag, and a second nucleic acid primer immobilized to the solid support, wherein the second nucleic acid primer includes a nucleic acid sequence that is the same as the second region of the oligonucleotide tag (FIG. 1). In some aspects of the invention, such solid supports further include a binding complex between the first antibody fragment and the first epitope of the unique target analyte, and the second antibody fragment and the second epitope of said unique target analyte, and a hybridization complex between the distinguishable oligonucleotide tag and the first nucleic acid primer (FIG. 2). In some aspects, the invention also provides an array that in includes a plurality of these solid supports in an array format as exemplified in FIGS. 5-6. For example, in some aspects, the plurality of solid supports can include at least 50, 100, 1,000, 10,000, 100,000, 1,000,000, 10,000,000, 100,000,000 or 1,000,000,000 solid supports.

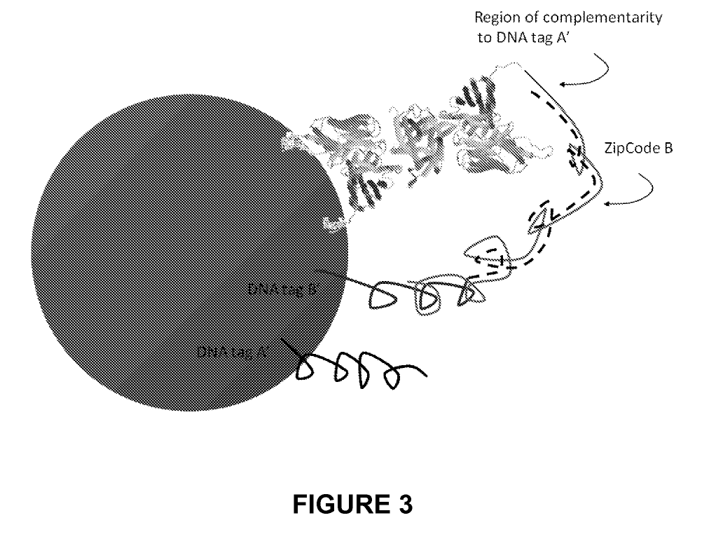

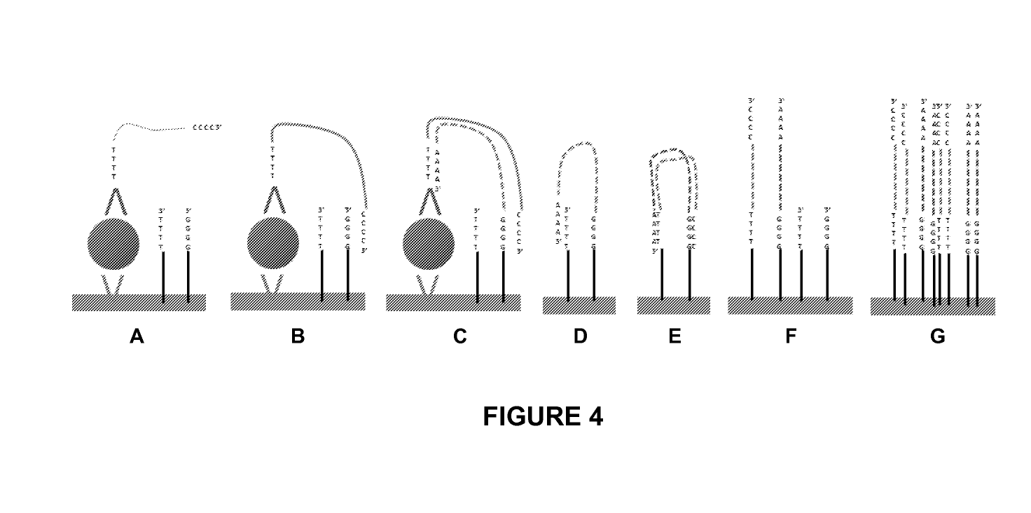

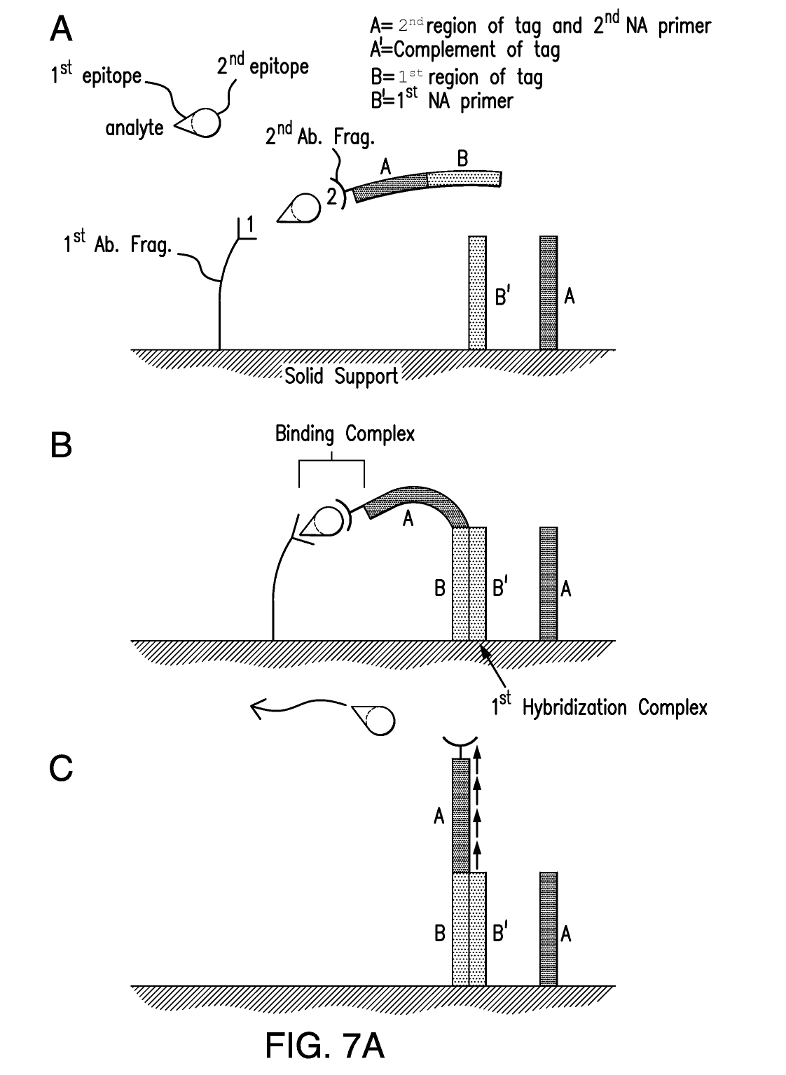

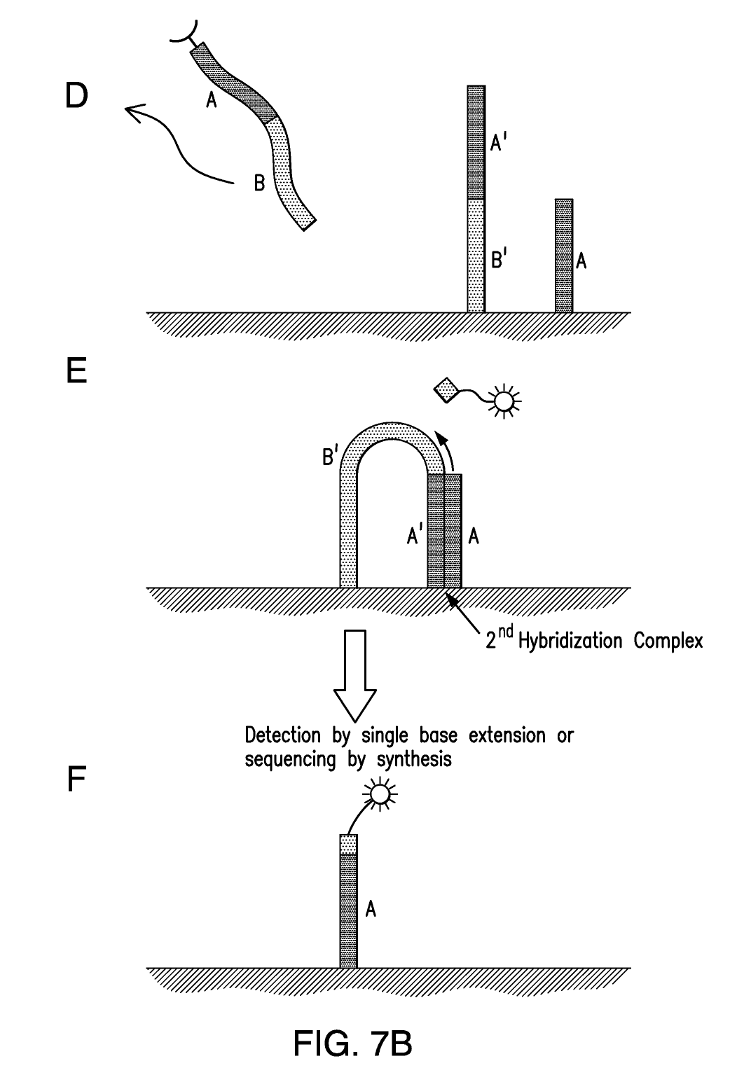

The invention further provides that such solid supports can be used in a method for detecting numerous target analytes. In one embodiment of the present invention, the invention provides a method for detecting a target analyte includes providing a solid support having: a first binding protein, such as an antibody fragment, immobilized to the solid support, wherein the first binding protein includes a binding region specific for a first epitope of the target analyte; a first nucleic acid primer immobilized to the solid support, wherein the first nucleic acid primer includes a nucleic acid sequence that is complementary to a first region of an oligonucleotide tag, and a second nucleic acid primer immobilized to the solid support, wherein the second nucleic acid primer includes a nucleic acid sequence that is the same as a second region of the oligonucleotide tag; providing a second binding protein, such as an antibody fragment, that is linked for attached to the oligonucleotide tag, wherein the oligonucleotide tag includes a first and a second region and wherein the second binding protein includes a binding region specific for a second epitope of said target analyte, wherein the second epitope is distinguishable from the first epitope; contacting the solid support with the second binding protein and the target analyte under sufficient conditions to form a binding complex between: the first binding protein and the first epitope of target analyte, and the second binding protein and the second epitope of the target analyte; hybridizing the oligonucleotide tag to the first nucleic acid primer thereby forming a hybridization complex; extending the first nucleic acid primer whereby a complement of said oligonucleotide tag is generated; amplifying the complement of the oligonucleotide tag using the second nucleic acid primer thereby forming an amplicon, and detecting the presence of the amplicon, wherein the presence of the amplicon indicates the presence of the target acid analyte (FIGS. 3-4). Moreover, the invention also provides a method for detecting a target analyte, wherein the method described above alternatively proceeds following the extension of the first nucleic acid primer by hybridizing the complement of the oligonucleotide tag that is generated to a second nucleic acid primer immobilized on the solid support forming a second hybridization complex, then extending the second nucleic acid primer with at least one labeled nucleic acid residue, using methods such as single base extension or sequencing by synthesis, wherein the nucleic acid residue added to the primer is dependent on the nucleic acid sequence of the oligonucleotide tag, followed by detecting the presence of the labeled nucleic acid residue on the solid surface, wherein the presence of the labeled nucleic acid residue indicates the presence of the target analyte (FIGS. 7A and 7B).

In some aspects of the invention, as disclosed herein, both the first and second binding proteins are antibody fragments, which can be independently a Fd, a Fv, a Fab, a F(ab′), a F(ab)2, a F(ab′)2, a single chain Fv (scFv), a diabody, a triabody, a tetrabody or a minibody. Methods for generating and using such antibody fragments are well known in the art as discussed herein. In some aspects of the invention, the target analyte is a non-nucleic acid analyte, such as a protein or polypeptide. Moreover, in some aspects of the invention, the solid support used in the method is a bead.

By “target analyte” or “analyte” or grammatical equivalents herein is meant any molecule, compound or particle to be detected. As outlined herein, target analytes bind to binding ligands such as, but not limited to, antibody fragments. As will be appreciated by those in the art, a large number of analytes may be detected using the present methods; basically, any target analyte for which a binding ligand, as described herein, can be made may be detected using the methods of the invention.

Suitable analytes include organic and inorganic molecules, including biomolecules. In one embodiment, the analyte may be a non-nucleic acid analyte such as, but not limited to: proteins (including enzymes, antibodies, antigens, growth factors, cytokines, etc); a chemical (including solvents, polymers, organic materials, etc.); therapeutic molecules (including therapeutic and abused drugs, antibiotics, etc.); biomolecules (including hormones, cytokines, proteins, lipids, carbohydrates, cellular membrane antigens and receptors (neural, hormonal, nutrient, and cell surface receptors or their ligands, etc)); whole cells (including prokaryotic (such as pathogenic bacteria) and eukaryotic cells (including mammalian tumor cells)); viruses (including retroviruses, herpesviruses, adenoviruses, lentiviruses, etc.); spores, and an environmental pollutant (including pesticides, insecticides, toxins, etc.).

In one embodiment, the target analyte is a protein. As will be appreciated by those in the art, there are a large number of possible proteinaceous target analytes that may be detected using the present invention. By “proteins” or grammatical equivalents herein is meant proteins, oligopeptides and peptides, derivatives and analogs, including proteins containing non-naturally occurring amino acids arid amino acid analogs, and peptidomimetic structures. The side chains may be in either the (R) or the (S) configuration. In one embodiment, the amino acids are in the (S) or L-configuration.

In one embodiment, the invention provides that the target analyte is a cancer marker. As used herein, a “cancer marker” refers to any biomolecule, protein, polypeptide or nucleic acid that is known to or has been previously determined to be associated with the development or progression of cancer in an individual or subject, such as a mammal including humans. It is understood that cancer markers are well known in the art and a skilled artisan can readily identify a desired cancer marker that can be assayed using the methods disclosed herein. Moreover, methods for obtaining and preapring samples that may include one or more cancer marker are well known in the art. Non-limiting examples of cancer markers that can be assayed using the methods disclosed herein include Citron Rho-interacting kinase, Phosphatidylinositol 3-kinase regulatory subunit beta, Chromodomain-helicase-DNA-binding protein 1, Myeloid leukemia factor 1, Src-like-adapter 2, Ankyrin repeat domain-containing protein 11, Protein C-ets-2, PR domain zincfinger protein 2, Huntingtin-interacting protein 1, Filamin-B, CASP8, FADD-like apoptosis regulator, Spectrin alpha chain (brain), Ras-related protein Rab-32, Tumor protein p73, RalA-binding protein 1, Brefeldin A-inhibited guanine nucleotide-exchange protein 2, G protein-coupled receptor kinase 7, A-kinase anchor protein 14, Protein unc-119 homolog A, Putative hydrolase RBBP9, Transcription factor E2F3, Enhancer of filamentation 1, TOM1-like protein 1, Prospero homeobox protein 1 and Stress-induced-phosphoprotein 1.

By “solid support,” “substrate” or other grammatical equivalents herein is meant any material that can be modified to contain discrete individual sites appropriate for the attachment or association of compositions disclosed herein and is amenable to at least one detection method. As will be appreciated by those in the art, the number of possible substrates is very large. Possible substrates include, but are not limited to, glass and modified or functionalized glass, plastics (including acrylics, polystyrene and copolymers of styrene and other materials, polypropylene, polyethylene, polybutylene, polyurethanes, Teflon, etc.), polysaccharides, nylon or nitrocellulose, resins, silica or silica-based materials including silicon and modified silicon, carbon, metals, inorganic glasses, plastics, optical fiber bundles, and a variety of other polymers. In general, the substrates allow optical detection and do not themselves appreciably fluoresce.

Generally the substrate is flat (planar), although as will be appreciated by those in the art, other configurations of substrates may be used as well; for example, three dimensional configurations can be used, for example by embedding beads in a porous block of plastic that allows sample access to the beads and using a confocal microscope for detection. Similarly, the beads may be placed on the inside surface of a tube, for flow-through sample analysis to minimize sample volume. In some aspects substrates include optical fiber bundles and flat planar substrates such as glass, polystyrene and other plastics and acrylics.

By “microspheres” or “beads” or “particles” or grammatical equivalents herein is meant small discrete particles. The composition of the beads will vary, depending on the class of capture probe and the method of synthesis. Suitable bead compositions include those used in peptide, nucleic acid and organic moiety synthesis, including, but not limited to, plastics, ceramics, glass, polystyrene, methylstyrene, acrylic polymers, paramagnetic materials, thoriasol, carbon graphite, titanium dioxide, latex or cross-linked dextrans such as Sepharose, cellulose, nylon, cross-linked micelles and Teflon may all be used. “Microsphere Detection Guide” from Bangs Laboratories, Fishers IN is a helpful guide.

The beads need not be spherical; irregular particles may be used. In addition, the beads may be porous, thus increasing the surface area of the bead available for either capture probe attachment or tag attachment. The bead sizes range from nanometers, i.e. 100 nm, to millimeters, i.e. 1 mm, with beads from about 0.2 micron to about 200 microns being preferred, and from about 0.5 to about 5 micron being particularly preferred, although in some embodiments smaller beads may be used.

As used herein, the term “nucleic acid” is intended to mean a ribonucleic or deoxyribonucleic acid or analog thereof, including a nucleic acid analyte presented in any context; for example, a probe, target or primer. Particular forms of nucleic acids of the invention include all types of nucleic acids found in an organism as well as synthetic nucleic acids such as polynucleotides produced by chemical synthesis. Particular examples of nucleic acids that are applicable for analysis through incorporation into microarrays produced by methods of the invention include genomic DNA (gDNA), expressed sequence tags (ESTs), DNA copied messenger RNA (cDNA), RNA copied messenger RNA (cRNA), mitochondrial DNA or genome, RNA, messenger RNA (mRNA) and/or other populations of RNA. Fragments and/or portions of these exemplary nucleic acids also are included within the meaning of the term as it is used herein.

As used herein, the term “binding protein” refers to any protein, polypeptide or macromolecule having a polypeptide region that is capable of binding a target analyte. Non-limiting example of binding proteins that are suitable for the compositions and methods disclosed here include antibodies, both monoclonal and polyclonal, antibody fragments, peptides, cells surface receptors, fusion proteins and the like. Moreover, combinations of binding proteins may also be used in the compositions and methods disclosed herein.

As used herein, the term “antibody” is intended to mean a polypeptide product of B cells within the immunoglobulin class of polypeptides which is composed of heavy and light chains and able to bind with a specific molecular target or antigen. The term “monoclonal antibody” refers to an antibody that is the product of a single cell clone or hybridoma. The term also is intended to refer to an antibody produced recombinant methods from heavy and light chain encoding immunoglobulin genes to produce a single molecular immunoglobulin species Amino acid sequences for antibodies within a monoclonal antibody preparation are substantially homogeneous and the binding activity of antibodies within such a preparation exhibit substantially the same antigen binding activity. The term “polyclonal antibodies” refers to antibodies that are obtained from different B cell resources, which are a combination of immunoglobulin molecules secreted again a specific antigen, but each immunoglobulin is specific for a different epitope of the same antigen. Methods for producing both monoclonal antibodies and polyclonal antibodies are well known in the art (Harlow and Lane, Antibodies: A Laboratory Manual, Cold Spring Harbor Laboratory Press (1989) and Antibody Engineering: A Practical Guide, C. A. K. Borrebaeck, Ed., W.H. Freeman and Co., Publishers, New York, pp. 103-120 (1991)).

As used herein, the term “antibody fragment” is intended to mean a portion of an antibody which still retains some or all of the target analyte specific binding activity. Such functional fragments can include, for example, antibody functional fragments such as Fd, Fv, Fab, F(ab′), F(ab)₂, F(ab′)₂, single chain Fv (scFv), diabodies, triabodies, tetrabodies and minibody. Other functional fragments can include, for example, heavy (H) or light (L) chain polypeptides, variable heavy (VH) and variable light (VL) chain region polypeptides, complementarity determining region (CDR) polypeptides, single domain antibodies, and polypeptides that contain at least a portion of an immunoglobulin that is sufficient to retain target analyte specific binding activity. Such antibody binding fragments can be found described in, for example, Harlow and Lane, Antibodies: A Laboratory Manual, Cold Spring Harbor Laboratory, New York (1989); Molec. Biology and Biotechnology: A Comprehensive Desk Reference (Myers, R. A. (ed.), New York: VCH Publisher, Inc.); Huston et al., Cell Biophysics, 22:189-224 (1993); Plückthun and Skerra, Meth. Enzymol., 178:497-515 (1989) and in Day, E. D., Advanced Immunochemistry, Second Ed., Wiley-Liss, Inc., New York, NY (1990).

With respect to antibodies and antibody fragments, various forms, alterations and modifications are well known in the art. The target analyte specific antibody fragments of the invention can include any of such various antibody forms, alterations and modifications. Examples of such various forms and terms as they are known in the art are set forth below.

A Fab fragment refers to a monovalent fragment consisting of the V_{L}, V_{H}, C_{L} and C_{H}1 domains; a F(ab′)₂ fragment is a bivalent fragment comprising two Fab fragments linked by a disulfide bridge at the hinge region; a Fd fragment consists of the V_{H} and C_{H}1 domains; an Fv fragment consists of the V_{L} and V_{H} domains of a single arm of an antibody; and a dAb fragment (Ward et al., Nature 341:544-546, (1989)) consists of a V_{H} domain.

An antibody can have one or more binding sites. If there is more than one binding site, the binding sites may be identical to one another or may be different. For example, a naturally occurring immunoglobulin has two identical binding sites, a single-chain antibody or Fab fragment has one binding site, while a “bispecific” or “bifunctional” antibody has two different binding sites.

A single-chain antibody (scFv) refers to an antibody in which a V_{L} and a V_{H} region are joined via a linker (e.g., a synthetic sequence of amino acid residues) to form a continuous polypeptide chain wherein the linker is long enough to allow the protein chain to fold back on itself and form a monovalent antigen binding site (see, e.g., Bird et al., Science 242:423-26 (1988) and Huston et al., Proc. Natl. Acad. Sci. USA 85:5879-83 (1988)). Diabodies refer to bivalent antibodies comprising two polypeptide chains, wherein each polypeptide chain comprises V_{H} and V_{L} domains joined by a linker that is too short to allow for pairing between two domains on the same chain, thus allowing each domain to pair with a complementary domain on another polypeptide chain (see, e.g., Holliger et al., Proc. Natl. Acad. Sci. USA 90:6444-48 (1993), and Poljak et al., Structure 2:1121-23 (1994)). If the two polypeptide chains of a diabody are identical, then a diabody resulting from their pairing will have two identical antigen binding sites. Polypeptide chains having different sequences can be used to make a diabody with two different antigen binding sites. Similarly, tribodies and tetrabodies are antibodies comprising three and four polypeptide chains, respectively, and forming three and four antigen binding sites, respectively, which can be the same or different.

A CDR refers to a region containing one of three hypervariable loops (H1, H2 or H3) within the non-framework region of the immunoglobulin (Ig or antibody) VH β-sheet framework, or a region containing one of three hypervariable loops (L1, L2 or L3) within the non-framework region of the antibody V_{L} β-sheet framework. Accordingly, CDRs are variable region sequences interspersed within the framework region sequences. CDR regions are well known to those skilled in the art and have been defined by, for example, Kabat as the regions of most hypervariability within the antibody variable (V) domains (Kabat et al., J. Biol. Chem. 252:6609-6616 (1977); Kabat, Adv. Prot. Chem. 32:1-75 (1978)). CDR region sequences also have been defined structurally by Chothia as those residues that are not part of the conserved β-sheet framework, and thus are able to adapt different conformations (Chothia and Lesk, J. Mol. Biol. 196:901-917 (1987)). Both terminologies are well recognized in the art. The positions of CDRs within a canonical antibody variable domain have been determined by comparison of numerous structures (Al-Lazikani et al., J. Mol. Biol. 273:927-948 (1997); Morea et al., Methods 20:267-279 (2000)). Because the number of residues within a loop varies in different antibodies, additional loop residues relative to the canonical positions are conventionally numbered with a, b, c and so forth next to the residue number in the canonical variable domain numbering scheme (Al-Lazikani et al., supra (1997)). Such nomenclature is similarly well known to those skilled in the art.

For example, CDRs defined according to either the Kabat (hypervariable) or Chothia (structural) designations, are set forth in the Table 1 below.

TABLE 1
CDR Definitions

| | Kabat¹ | Chothia² | Loop Location |
|---|---|---|---|
| V_{H} CDR1 | 31-35 | 26-32 | linking B and C strands |
| V_{H} CDR2 | 50-65 | 53-55 | linking C’ and C” strands |
| V_{H} CDR3 | 95-102 | 96-101 | linking F and G strands |
| V_{L} CDR1 | 24-34 | 26-32 | linking B and C strands |
| V_{L} CDR2 | 50-56 | 50-52 | linking C’ and C” strands |
| V_{L} CDR3 | 89-97 | 91-96 | linking F and G strands |

¹Residue numbering follows the nomenclature of Kabat et al., supra
²Residue numbering follows the nomenclature of Chothia et al., supra

One or more CDRs also can be incorporated into a molecule either covalently or noncovalently to make it an immunoadhesin. An immunoadhesin can incorporate the CDR(s) as part of a larger polypeptide chain, can covalently link the CDR(s) to another polypeptide chain, or can incorporate the CDR(s) noncovalently. The CDRs permit the immunoadhesin to specifically bind to a particular antigen of interest.

The terms “binding,” “binds,” “recognition,” or “recognize” as used herein are meant to include interactions between molecules that may be detected using, for example, a hybridization assay. The terms are also meant to include “binding” interactions between molecules. Interactions may be, for example, protein-protein, protein-nucleic acid, protein- small molecule or small molecule-nucleic acid in nature. This binding can result in the formation of a “complex” comprising the interacting molecules. A “complex” refers to the binding of two or more molecules held together by covalent or non-covalent bonds, interactions or forces.

An epitope refers to a part of a molecule, for example, a portion of a polypeptide, that specifically binds to one or more antibodies within the antigen binding site of the antibody or antibody fragment. Epitopic determinants can include continuous or non-continuous regions of the molecule that binds to an antibody or antibody fragment. Epitopic determinants also can include chemically active surface groupings of molecules such as amino acids or sugar side chains and have specific three dimensional structural characteristics and/or specific charge characteristics. Additionally, when an epitope as disclosed herein is “distinguishable” from another epitope, it is understood that the epitopes are capable of being perceived or identified as different or distinct from each other, which includes, but is not limited to, the epitopes having different primary amino acid sequences, different secondary structures (the general three-dimensional form of the local segments of the polynucleotide) or different amino acid modifications (including acylation, alkylation, gamma-carboxylation, glycosylation, phosphorylation, sulfation, biotinylation, pegylation, disulfide bridges).

As used herein, the term “specific” when used in reference to an antibody or antibody fragment binding activity is intended to mean that the referenced antibody or antibody fragment exhibits preferential binding for a target analyte compared to other target analytes. Preferential binding includes an antibody or antibody fragment of the invention exhibiting detectable binding to on target analyte while exhibiting little or no detectable binding to another target analyte.

As used herein, the term “affinity” or a grammatical equivalent thereof, is intended to mean the attractive force exerted between substances that causes them to enter into and/or remain in combination. For example, when used in reference to the attraction of an antibody fragment to a target analyte the term is intended to refer to the strength at which an antibody fragment and a target analyte associate. The measure of the strength of association can be, for example, qualitative, relative, or quantitative. The type of association can include, for example, non-covalent interactions, covalent interactions. Specific examples of non-covalent interactions include electrostatic forces, hydrogen bonding and/or Van der Waal's forces. A specific example of a covalent interaction includes chemical bond formation.

A “primer” is a short polynucleotide, generally with a free 3′-OH group that binds to a target or “template” potentially present in a sample of interest by hybridizing with the target, and thereafter promoting polymerization of a polynucleotide complementary to the target. A “polymerase chain reaction” (“PCR”) is a reaction in which replicate copies are made of a target polynucleotide using a “pair of primers” or a “set of primers” consisting of an “upstream” and a “downstream” primer, and a catalyst of polymerization, such as a DNA polymerase, and typically a thermally-stable polymerase enzyme. Methods for PCR are well known in the art, and taught, for example in MacPherson et al. (1991) PCR 1: A Practical Approach (IRL Press at Oxford University Press). A primer can also be used as a probe in hybridization reactions, such as Southern or Northern blot analyses. Sambrook and Russell (2000), Cold Spring Harbor Laboratory Press, U.S.; 3rd Revised edition. Primers of the instant invention are comprised of nucleotides ranging from 10 to 1000 or more nucleotides. In one aspect, the primer is no more than 10 nucleotides, or alternatively, no more than 15 nucleotides, or alternatively, no more than 20 nucleotides, or alternatively, no more than 20 nucleotides, or alternatively, no more than 30 nucleotides, or alternatively, no more than 40 nucleotides, or alternatively, no more than 50 nucleotides, or alternatively, no more than 60 nucleotides, or alternatively, no more than 70 nucleotides, or alternatively, no more than 80 nucleotides, or alternatively, no more than 90 nucleotides, or alternatively, no more than 100 nucleotides, or alternatively, no more than 200 nucleotides, or alternatively, no more than 300 nucleotides, or alternatively no more than 400 nucleotides, or alternatively no more than 500 nucleotides or alternatively no more than 1000 nucleotides.

When hybridization occurs in an antiparallel configuration between two single-stranded polynucleotides, the reaction is called “annealing” and those polynucleotides are described as “complementary”. A double-stranded polynucleotide can be complementary or homologous to another polynucleotide, if hybridization can occur between one of the strands of the first polynucleotide and the second. Complementarity or homology (the degree that one polynucleotide is complementary with another) is quantifiable in terms of the proportion of bases in opposing strands that are expected to form hydrogen bonding with each other, according to generally accepted base-pairing rules.

The terms “oligonucleotide” and “polynucleotide” are used interchangeably and refer to a polymeric form of nucleotides of any length, either deoxyribonucleotides or ribonucleotides or analogs thereof. Polynucleotides can have any three-dimensional structure and may perform any function, known or unknown. The following are non-limiting examples of oligonucleotide: a gene or gene fragment (for example, a probe, primer, EST or SAGE tag), genomic DNA, genomic DNA fragment, exon, intron, messenger RNA (mRNA), transfer RNA, ribosomal RNA, ribozyme, cDNA, recombinant polynucleotide, branched polynucleotide, plasmid, vector, isolated DNA of any sequence, isolated RNA of any sequence, nucleic acid probe, primer or amplified copy of any of the foregoing. A polynucleotide can comprise modified nucleotides, such as methylated nucleotides and nucleotide analogs. If present, modifications to the nucleotide structure can be imparted before or after assembly of the oligonucleotide. The sequence of nucleotides can be interrupted by non-nucleotide components. An oligonucleotide can be further modified after polymerization, such as by conjugation with a labeling component. The term also refers to both double- and single-stranded molecules. Unless otherwise specified or required, any embodiment of this invention that makes or uses a oligonucleotide encompasses both the double-stranded form and each of two complementary single-stranded forms known or predicted to make up the double-stranded form. Unless otherwise specified or required, a “copy” of a oligonucleotide can include the exact copy of the oligonucleotide and the complementary copy of the oligonucleotide in single or double stranded form. In some aspects of the invention, the lengths of the oligonucleotides disclosed herein are at least 10, 20, 30, 40, 50, 60, 70, 80, 90, 100, 150, 200, 300, 400 or 500 or more nucleotides. Alternatively or additionally, the lengths are no more than 1000, 900, 800, 700, 600, 500, 400, 300, 200, 150, 100, 90, 80, 70, 60, 50, 40, 30 or 20 nucleotides.

In some aspects of the compositions or methods described herein, the nucleic acids on a bead or solid support have a “capture sequence”. A “capture sequence” refers to a stretch of nucleotides which when hybridized to a complementary nucleotide sequence present on a polynucleotide or clonal object gains control of or becomes associated with any attached molecule, such as a bead or solid surface. The capture sequence can be continuous or non-continuous and will depend on the a number of variables including, but not limited to, the size of the attached molecule, the location of the capture sequence within the polynucleotide and the hybridization methods used. A sequence having sufficient complementarity to a capture sequence to allow specific hybridization is referred to herein as a “capture-complement sequence.” In particular embodiments, the capture-complement sequence includes a sequence that is perfectly complementary to the capture sequence. The length of the capture sequence and/or the capture-complement sequence can be at least 10, 20, 30, 40, 50, 60, 70, 80, 90, 100, 150, 200, 300, 400 or 500 or more nucleotides. Alternatively or additionally, the lengths are no more than 1000, 900, 800, 700, 600, 500, 400, 300, 200, 150, 100, 90, 80, 70, 60, 50, 40, 30 or 20 nucleotides. Capture sequences and capture-complement sequences are examples of capture moieties and capture-complement moieties, respectively. Capture sequences and capture complement sequences can also function as affinity ligands. Although several embodiments of the invention are exemplified herein with respect to capture sequences and capture-complement sequences, it will be understood that other moieties can be used such as affinity ligands set forth elsewhere herein or other moieties known in the art that are capable of specific binding interactions.

A oligonucleotide can be composed of a specific sequence of four nucleotide bases: adenine (A); cytosine (C); guanine (G); and thymine (T). Uracil (U) can also be present, for example, as a natural replacement for thymine when the polynucleotide is RNA. Uracil can also be used in DNA. Thus, the term “sequence” is the alphabetical representation of a polynucleotide, oligonucleotide or nucleic acid molecule. This alphabetical representation can be input into databases in a computer having a central processing unit and used for bioinformatics applications such as functional genomics, sequence alignment, sequence building and homology searching.

A nucleic acid used in the invention can also include native or non-native bases. In this regard a native deoxyribonucleic acid can have one or more bases selected from the group consisting of adenine, thymine, cytosine or guanine and a ribonucleic acid can have one or more bases selected from the group consisting of uracil, adenine, cytosine or guanine. It will be understood that a deoxyribonucleic acid used in the methods or compositions set forth herein can include uracil bases and a ribonucleic acid can include a thymine base. Exemplary non-native bases that can be included in a nucleic acid, whether having a native backbone or analog structure, include, without limitation, inosine, xathanine, hypoxathanine, isocytosine, isoguanine, 2-aminopurine, 5-methylcytosine, 5-hydroxymethyl cytosine, 2-aminoadenine, 6-methyl adenine, 6-methyl guanine, 2-propyl guanine, 2-propyl adenine, 2-thioLiracil, 2-thiothymine, 2-thiocytosine, 15-halouracil, 15-halocytosine, 5-propynyl uracil, 5-propynyl cytosine, 6-azo uracil, 6-azo cytosine, 6-azo thymine, 5-uracil, 4-thiouracil, 8-halo adenine or guanine, 8-amino adenine or guanine, 8-thiol adenine or guanine, 8-thioalkyl adenine or guanine, 8-hydroxyl adenine or guanine, 5-halo substituted uracil or cytosine, 7-methylguanine, 7-methyladenine, 8-azaguanine, 8-azaadenine, 7-deazaguanine, 7-deazaadenine, 3-deazaguanine, 3-deazaadenine or the like. A particular embodiment can utilize isocytosine and isoguanine in a nucleic acid in order to reduce non-specific hybridization, as generally described in U.S. Pat. No. 5,681,702.

A non-native base used in a nucleic acid of the invention can have universal base pairing activity, wherein it is capable of base pairing with any other naturally occurring base. Exemplary bases having universal base pairing activity include 3-nitropyrrole and 5-nitroindole. Other bases that can be used include those that have base pairing activity with a subset of the naturally occurring bases such as inosine, which basepairs with cytosine, adenine or uracil. Non-native bases can be modified to include a peptide-linked label. The peptide can be attached to the base using methods exemplified herein with regard to native bases. Those skilled in the art will know or be able to determine appropriate methods for attaching peptides based on the reactivities of these bases. Alternatively or additionally, oligonucleotides, nucleotides or nucleosides including the above-described non-native bases can further include reversible blocking groups on the 2′, 3′ or 4′ hydroxyl of the sugar moiety.

In some embodiments, the present invention provides a method for detecting a target non-nucleic acid analyte by: providing a solid support having, a first antibody fragment immobilized to the solid support, wherein the first antibody fragment includes a binding region specific for a first epitope of the target non-nucleic acid analyte; a first nucleic acid primer immobilized to the solid support, wherein the first nucleic acid primer includes a nucleic acid sequence that is complementary to a first region of an oligonucleotide tag, and a second nucleic acid primer immobilized to the solid support, wherein the second nucleic acid primer includes a nucleic acid sequence that is the same as a second region of the oligonucleotide tag; providing a second antibody fragment linked or attached to said oligonucleotide tag, wherein the oligonucleotide tag includes a first and a second region and wherein the second antibody fragment includes a binding region specific for a second epitope of the target non-nucleic acid analyte, wherein the second epitope is distinguishable from said first epitope; contacting the solid support with the second antibody fragment and the target non-nucleic acid analyte under sufficient conditions to form a binding complex between: the first antibody fragment and the first epitope of said target non-nucleic acid analyte, and the second antibody fragment and the second epitope of the target non-nucleic acid analyte; hybridizing the oligonucleotide tag to the first nucleic acid primer thereby forming a hybridization complex; extending the first nucleic acid primer whereby a complement of the oligonucleotide tag is generated; amplifying the complement of the oligonucleotide tag using the second nucleic acid primer thereby forming an amplicon, and detecting the presence of said amplicon, wherein the presence of the amplicon indicates the presence of the target non-nucleic acid analyte.

In some embodiments, the present invention provides a method for detecting a target non-nucleic acid analyte by: providing a solid support having, a first antibody fragment immobilized to the solid support, wherein the first antibody fragment includes a binding region specific for a first epitope of the target non-nucleic acid analyte; a first nucleic acid primer immobilized to the solid support, wherein the first nucleic acid primer includes a nucleic acid sequence that is complementary to a first region of an oligonucleotide tag, and a second nucleic acid primer immobilized to the solid support, wherein the second nucleic acid primer includes a nucleic acid sequence that is the same as a second region of the oligonucleotide tag; providing a second antibody fragment linked or attached to said oligonucleotide tag, wherein the oligonucleotide tag includes a first and a second region and wherein the second antibody fragment includes a binding region specific for a second epitope of the target non-nucleic acid analyte, wherein the second epitope is distinguishable from said first epitope; contacting the solid support with the second antibody fragment and the target non-nucleic acid analyte under sufficient conditions to form a binding complex between: the first antibody fragment and the first epitope of said target non-nucleic acid analyte, and the second antibody fragment and the second epitope of the target non-nucleic acid analyte; hybridizing the oligonucleotide tag to the first nucleic acid primer thereby forming a hybridization complex; extending the first nucleic acid primer whereby a complement of the oligonucleotide tag is generated; hybridizing the complement of the oligonucleotide tag to the second nucleic acid primer thereby forming a second hybridization complex; extending the second nucleic acid primer with at least one labeled nucleic acid residue, wherein said extension is dependent on the formation of the second hybridization complex, and detecting the presence of the labeled nucleic acid residue, wherein the presence of the labeled nucleic acid residue indicates the presence of the target non-nucleic acid analyte.

In some aspects of the present invention, the binding protein, such as an antibody fragment and/or the nucleic acid primers are immobilized to the solid support through a covalent bond. Methods for immobilizing proteins and nucleic acids to solid support by covalent bonds are well known in the art. For example, a variety of surface chemistries can be used to immobilize a binding protein to a solid surface including covalent bonding of amine groups on proteins to aldehyde or epoxide groups on silanized glass surfaces, or other functional groups on a solid support (see Guo and Zhu, (2007) “The Critical Role of Surface Chemistry in Protein Microarrays” in Functional Protein Microarrays in Drug Discovery, Ed. Paul F. Predki, CRC Press, Chapter 4, pgs 53-71). Methods for immobilizing nucleic acids to a solid support are also well know in the art. For example, nucleic acids can be synthesized directly on the solid surface using a variety of well known methods such as the phosphoramidite method, which uses phosphoramidite building blocks derived from protected 2′-deoxynucleosides (dA, dC, dG, and T), ribonucleosides (A, C, G, and U), or chemically modified nucleosides, e.g. locked nucleic acid (LNA). Moreover, already synthesized oligonucleotides can be immobilized to the solid support using amine-modified oligonucleotides, which are covalently linked to an activated carboxylate group or succinimidyl on the solid surface, thiol-modified oligonucleotides, which are covalently linked via an alkylating reagent such as an iodoacetamide or maleimide on the solid surface, phosphoramidite-modified oligonucleotides, which are covalently linked through a thioether, disulfide modified oligonucleotides, which are immobilized by mercaptosilanized glass supports, hydrazide modified oligonucleotides, which are immobilized by aldehyde or epoxide coated supports, biotin-modified oligonucleotides, which are captured by immobilized streptavidin molecules, and the like.

In some aspects of the invention, the binding proteins and/or nucleic acid primers can be immobilized to a solid support using non-covalent bonding. For example, is some aspects of the invention the binding protein, such as an antibody fragment further includes a nucleic acid capture sequence, which can be used to immobilize the binding protein to a solid support that includes a capture probe immobilized thereto. In this example, the binding protein is immobilized to the solid supporting using hybridization between the capture sequence and the capture probe. Similarly, the nucleic acid primers disclosed herein can also be immobilized to the solid support using capture probes that hybridize to a portion of the nucleic acid primer. In this context, it is understood that nucleic acid primers immobilized in this fashion also include an additional nucleic acid sequence that can be use as a primer as disclosed in the methods and compositions disclosed herein.

In some aspects, the invention provides that the nucleic acid primers have a length that provides a sufficient number of residues to allow a hybridization complex to form between the oligonucleotide tag or its complement and the primers immobilized on the solid surface. Additionally, the primers immobilized on the surface are of a sufficient nucleotide residue composition as to prevent cross hybridization with each other. For example, the invention provides that in some aspects the first nucleic acid primer is no more than 20, 30, 40, 50, 60, 70, 80, 90 or 100 residues in length. The invention also provides that in some aspects the second nucleic acid primer is no more than 20, 30, 40, 50, 60, 70, 80, 90 or 100 residues in length. Yet further, the invention provides that the oligonucleotide tag is also of a sufficient length and composition as to allow it to form a hybridization complex with the nucleic acid primers immobilized on the solid support once the binding complex between the two bind proteins and the target analyte are formed. For example, in some aspects the oligonucleotide tag is no more than 50, 100, 150, 200, 300, 400 or 500 residues in length.

In some aspects of the invention, the methods disclosed herein further include that the affinity of the binding complexes between the first binding proteins, such as an antibody fragment, and the first epitope of a target analyte, and the binding protein, such as an antibody fragment, and the second epitope of the target analyte are each independently greater than the affinity of the hybridization complex formed between the oligonucleotide tag and first nucleic acid primer immobilized on the solid support (FIG. 2). In this context, the higher affinity allows for the methods disclosed herein to include a washing step, wherein any excess binding protein present in the reaction can be removed from each bead, while retaining the binding protein complexes with the target analyte. Accordingly, in some aspects of the invention, the methods disclosed herein further include removing from the solid support residual second antibody fragments which are not immobilized to the solid support through the binding complex. Moreover, the invention also provides that one or more wash steps can be included in the methods disclosed herein for removal of any unbound, unreacted or undersireable reaction component or combination of reaction components including, but not limited to, binding proteins, nucleic acids, oligonucleotides, target analytes, components for extension or amplification steps and the like. Methods for removal of such components are well known in the art. For example, removal of the residual binding proteins can include heating the support and/or washing the solid support with an appropriate solution, which will disrupt any hybridization complexes formed between the oligonucleotide tag and the immobilized primers in the absence of the binding complex. It is understood that a skilled artisan can readily determine the appropriate conditions for removal of these components using routine methods.

In some aspects, the present invention provides that the second binding protein, such as an antibody fragment, which includes the oligonucleotide tag, further includes a cleavable linker between the binding protein and the oligonucleotide tag. In this aspect, the cleavable linker provides for a method wherein the cleavable linker is cleaved following formation of the first hybridization complex between the oligonucleotide tag and the first nucleic acid primer immobilized to the solid support. By separating the oligonucleotide tag from the second binding protein, the entire binding complex between the target analyte and the first and second binding proteins can be removed from the solid surface. In this aspect, the later amplification and/or detection steps in the methods can be completed in the absence of potentially interfering macromolecules.

As used herein a “cleavable linker” refers to a compound which is reactive to a specific catalyst, which upon reacting with the catalyst releases any bound group. Examples of cleavable moieties include compounds that are reactive to, without limitation, proteases, enzymes, chemicals and light. In one aspect of the invention, a cleavable base/bases could be used as the cleavable linker, such as uracil, which is cleavable by an exogenous base cleaving agent such as DNA glycosylase (UDG) followed by heating or chemical methods which cleave the abasic site. Another example is a restriction enzyme motif cleavable by a restriction enzyme. Similarly, templates having 8-hydroxyguanine can be cleaved by 8-hydroxyguanine DNA glycosylase (FPG protein). Other exemplary exogenous bases and methods for their degradation that can be used are described in U.S. Patent Application Publication 2005-0181394, which is incorporated herein by reference.

Other cleavable moieties are useful for the invention including, a oligonucleotide having a protease cleavable linker to allow selective cleavage and separation of the oligonucleotide from the linked antibody fragment. As used herein, the term “protease” is intended to mean an agent that catalyzes the cleavage of peptide bonds in a protein or peptide. Some proteases are non-sequence specific proteases. Generally, for the methods disclosed herein, the protease has sequence specificity, splitting a peptide bond of a protein based on the presence of a particular amino acid sequence in the protein. A protease can be characterized according to the location in a protein where it cleaves, an endoprotease cleaving a protein between internal amino acids of an amino acid chain and an exoprotease cleaving a protein to remove an amino acid from the end of an amino acid chain. In the peptide linkers of the compositions herein, an endoprotease can be used. A protease can be characterized according to its mechanism of action, being identified, for example, as a serine protease, cysteine (thiol) protease, aspartic (acid) protease, metalloprotease or mixed protease depending on the principal amino acid participating in catalysis. A protease can also be classified based on the action pattern, examples of which include an aminopeptidase which cleaves an amino acid from the amino end of a protein, carboxypeptidase which cleaves an amino acid from the carboxyl end of a protein, dipeptidyl peptidase which cleaves two amino acids from an end of a protein, dipeptidase which splits a dipeptide and tripeptidase which cleaves an amino acid from a tripeptide. Typically, a protease is a protein enzyme. However, non-protein agents capable of catalyzing the cleavage of peptide bonds in a protein, especially in a sequence specific manner are also useful in the invention.

Activity of a protease includes binding of the protease to a protease substrate or hydrolysis of the protease substrate or both. The activity can be indicated, for example, as binding specificity, catalytic activity or a combination thereof The activity of a protease can be identified qualitatively or quantitatively in accordance with the compositions and methods disclosed herein. Exemplary qualitative measures of protease activity include, without limitation, identification of a substrate cleaved in the presence of the protease, identification of a change in substrate cleavage due to presence of another agent such as an inhibitor or activator, identification of an amino acid sequence that is recognized by the protease, identification of the composition of a substrate recognized by the protease or identification of the composition of a proteolytic product produced by the protease. Activity can be quantitatively expressed as units per milligram of enzyme (specific activity) or as molecules of substrate transformed per minute per molecule of enzyme (molecular activity). The conventional unit of enzyme activity is the International Unit (IU), equal to one micromole of substrate transformed per minute. A proposed coherent Systeme Internationale (SI) unit is the katal (kat), equal to one mole of substrate transformed per second.

A protease substrate includes a molecule that can be cleaved by a protease. A protease substrate is typically a protein, protein moiety or peptide having an amino acid sequence that is recognized by a protease. A protease can recognize the amino acid sequence of a protease substrate due to the specific sequence of side chains or due to properties generic to proteins. A protease substrate can also be a protein mimetic or non-protein molecule that is capable of being cleaved or otherwise covalently modified by a protease.

Exemplary proteases, corresponding peptide substrates and their commercial sources are shown in Table 2.

TABLE 2
Proteases and their cleavage preferences.

| | Peptide | |
|---|---|---|
| | (cleavage | |
| | site indicated | |
| Protease | with dash) | Company |
| Thrombin | LVPR-GS | Amersham, Novagen, |
| | | Sigma, Roche |
| Factor Xa | IEGR-X | Amersham, NEB, Roche |
| Enterokinase | DDDDK-X | NEB, Novagen, Roche |
| TEV protease | ENLYFQ-G | Invitrogen |
| PreScission | LEVLFQ-GP | Amersham |
| HRV 3C Protease | LEVLFQ-GP | Novagen |
| Trypsin | R-X, K-X | |
| Endoproteinase | X-D | |
| Asp-N | | |
| Chymotrypsin | Y-X, F-X, W-X | |
| Endoproteinase | E-X | |
| Glu-C | | |
| Endoproteinase | R-X | |
| Arg-C | | |
| Endoproteinase | K-X | |
| Lys-C | | |

Protease cleavable linkers used in the invention are generally peptides. Peptide synthesis can be carried out using standard solid phase or solution phase chemistry, as desired. Methods for peptide synthesis are well known to those skilled in the art (Fodor et. al., Science 251:767 (1991); Gallop et al., J. Med. Chem. 37:1233-1251 (1994); Gordon et al., J. Med. Chem. 37:1385-1401 (1994)). It is understood that a peptide linker can be synthesized and then added to the NTP as a peptide or can be synthesized by sequentially adding amino acids and then a dye.

In some aspects, the present invention also provides that the oligonucleotide tag further includes an analyte identifying sequence. As used herein, an “analyte identifying sequence” refers to a sequence of nucleic acid residues that supplies the necessary information to identify which target analyte was present on the solid surface. The analyte identifying sequence, for example, can be a continuous or non-continuous series of nucleic acid residues, which, when identified as being present on a solid surface following the methods disclosed herein, indicates that a specific or unique target analyte is present in the sample. Such analyte identifying sequences are also referred to herein as a “ZipCode.” It is understood that any number of nucleic acid combinations can be used as an identifying sequence and that it is well within the level of skill in the art to provide a unique analyte identifying sequence for each and every target analyte as disclosed herein.

Embodiments of the invention also provide a multiplex method for detecting a plurality of target analytes in a sample by providing a plurality of solid supports, such as beads (see FIG. 5), wherein each solid support independently includes a first binding protein, such as an antibody fragment, and at least two nucleic acid primers immobilized to the solid support, wherein the first binding protein recognizes and binds a unique target analyte, providing a plurality of second binding proteins, wherein each of the second binding proteins are linked or attached to a distinguishable oligonucleotide tag having a first and second region, and wherein each binding protein is capable of recognizing and binding one of the same target analytes at the same time as the first binding protein, contacting the plurality of solid supports with a sample having a plurality of unique target analytes in the presence of the plurality of second binding proteins under sufficient conditions to form binding complexes between the unique target analytes and first and second binding proteins, hybridizing the first region of the oligonucleotide tag present on the second binding protein to the first nucleic acid thereby forming a hybridization complex for each of the plurality of solid supports, extending this first primer whereby a complement of the oligonucleotide tag is generated for each of the plurality of solid supports, amplifying the newly generated complement using the second nucleic acid primer for each of the solid supports and detecting the presence of the amplicon for each of the solid supports, wherein the presence of the amplicon at an individual solid support indicates the presence of the unique target analyte in the sample. Moreover, the invention also provides a method for detecting a plurality of target analytes, wherein the method described above alternatively proceeds following the extension step by hybridizing the complement of the oligonucleotide tag that is generated to the second nucleic acid primer immobilized on the solid support by the second region in the tag forming a second hybridization complex for each of the solid supports, then extending the second nucleic acid primer with at least one labeled nucleic acid residue for each of the solid supports, using methods such as single base extension or sequencing by synthesis, wherein the nucleic acid residue added to the primer is dependent on the nucleic acid sequence of the oligonucleotide tag, followed by detecting the presence of the labeled nucleic acid residue on each of the solid supports, wherein the presence of the labeled nucleic acid residue indicates the presence of the unique target analyte in the sample.

As used herein, the term “plurality” is intended to mean a population of two or more different members. Pluralities can range in size from small, medium, large, to very large. The size of small plurality can range, for example, from a few members to tens of members. Medium sized pluralities can range, for example, from tens of members to about 100 members or hundreds of members. Large pluralities can range, for example, from about hundreds of members to about 1000 members, to thousands of members and up to tens of thousands of members. Very large pluralities can range, for example, from tens of thousands of members to about hundreds of thousands, a million, millions, tens of millions and up to or greater than hundreds of millions of members. Therefore, a plurality can range in size from two to well over one hundred million members as well as all sizes, as measured by the number of members, in between and greater than the above exemplary ranges. Exemplary nucleic acid pluralities include, for example, populations of about 1×10⁵, 5×10⁵ and 1×10⁶ or more different nucleic acid species. Accordingly, the definition of the term is intended to include all integer values greater than two. An upper limit of a plurality of the invention can be set, for example, by the theoretical diversity of nucleotide sequences in a nucleic acid sample of the invention.

The term “each,” when used in reference to individual members within a plurality, is intended to recognize one or more members in a population. Unless explicitly stated otherwise the term “each” when used in this context is not intended to require or necessarily recognize all of the members in a plurality. Thus, “each” is intended to be an open term.

Conditions for hybridization in the present invention are generally high stringency conditions as known in the art, although different stringency conditions can be used. Stringency conditions have been described, for example, in Sambrook et al., Molecular Cloning: A Laboratory Manual, 3d ed. (2000) or in Ausubel et al., Current Protocols in Molecular Biology (1998). High stringency conditions favor increased fidelity in hybridization, whereas reduced stringency permit lower fidelity. Stringent conditions are sequence-dependent and will be different in different circumstances. Longer sequences hybridize specifically at higher temperatures. An extensive guide to the hybridization of nucleic acids is found in Tijssen, “Overview of principles of hybridization and the strategy of nucleic acid assays” in Techniques in Biochemistry and Molecular Biology—Hybridization with Nucleic Acid Probes (1993). Generally, stringent conditions are selected to be about 5-10C.° lower than the thermal melting point (Tm) for the specific sequence at a defined ionic strength and pH. The Tm is the temperature (under defined ionic strength, pH and nucleic acid concentration) at which 50% of the probes complementary to the target hybridize to the target sequence at equilibrium (i.e., as the target sequences are present in excess, at Tm, 50% of the probes are occupied at equilibrium). Examples of stringent conditions are those in which the salt concentration is less than about 1.0 M sodium ion, typically about 0.01 to 1.0 M sodium ion concentration (or other salts) at pH 7.0 to 8.3 and the temperature at least about 30° C. for short probes (e.g. 10 to 50 nucleotides) and at least about 60° C. for long probes (e.g. greater than 50 nucleotides). Stringent conditions may also be achieved with the addition of helix-destabilizing agents such as formamide. Stringency can be controlled by altering a step parameter that is a thermodynamic variable such as temperature or concentrations of formamide, salt, chaotropic salt, pH, and/or organic solvent. These parameters may also be used to control non-specific binding, as is generally outlined in U.S. Pat. No. 5,681,697. Thus it may be desirable to perform certain steps at higher stringency conditions to reduce non-specific binding.

In some aspects, the present invention provides that the extension of a nucleic acid primer immobilized on the solid support following formation of a hybridization complex proceeds by use of a polymerase or a ligase. The terms “extending,” “extension” or any grammatical equivalents thereof when used in the context of the present invention refers to the addition of dNTPs to a primer, oligonucleotide, polynucleotide or other nucleic acid molecule by an extension enzyme such as a polymerase. For example, in some methods disclosed herein, the resulting extended primer thus includes sequence information of the target analyte, including the sequence of the specific analyte to be detected. Thus, the extended primer serves as the template in subsequent specificity steps to identify the target analyte by identifying a nucleotide at a specific detection position, i.e. the particular nucleic acid residue at a specific position in the oligonucleotide tag that specifically identifies the target analyte which was immobilized to the solid support.

By “extension enzyme” herein is meant an enzyme that will extend a sequence by the addition of NTPs. As is well known in the art, there are a wide variety of suitable extension enzymes, of which polymerases (both RNA and DNA, depending on the composition of the oligonucleotide tag) are particularly useful. Other additional polymerases that can be used in the methods of the invention are those that lack strand displacement activity, such that they will be capable of adding only the necessary bases at the end of the primer, without further extending the primer to include nucleotides that are complementary to a targeting domain and thus preventing circularization. Suitable polymerases include, but are not limited to, both DNA and RNA polymerases, including the Klenow fragment of DNA polymerase I, SEQUENASE 1.0 and SEQUENASE 2.0 (U.S. Biochemical), T5 DNA polymerase, Phi29 DNA polymerase and various RNA polymerases such as from Thermus sp., or Q beta replicase from bacteriophage, also SP6, T3, T4 and T7 RNA polymerases can be used, among others.

Moreover, polymerases that are particularly useful are those that are essentially devoid of a 5′ to 3′ exonuclease activity, so as to assure that the primer will not be extended past the 5′ end of the template oligonucleotide tag. Exemplary enzymes lacking 5′ to 3′ exonuclease activity include the Klenow fragment of the DNA Polymerase and the Stoffel fragment of DNAPTaq Polymerase. For example, the Stoffel fragment of Taq DNA polymerase lacks 5′ to 3′ exonuclease activity due to genetic manipulations, which result in the production of a truncated protein lacking the N-terminal 289 amino acids. (See e.g., Lawyer et al., J. Biol. Chem., 264:6427-6437 (1989); and Lawyer et al., PCR Meth. Appl., 2:275-287 (1993)). Analogous mutant polymerases have been generated for polymerases derived from T. maritima, Tsps17, TZ05, Tth and Taf.

Other useful polymerases include those that lack a 3′ to 5′ exonuclease activity, which is commonly referred to as a proof-reading activity, and which removes bases which are mismatched at the 3′ end of a primer-template duplex. Although the presence of 3′ to 5′ exonuclease activity provides increased fidelity in the strand synthesized, the 3′ to 5′ exonuclease activity found in thermostable DNA polymerases such as Tma (including mutant forms of Tma that lack 5′ to 3′ exonuclease activity) also degrades single-stranded DNA such as the primers used in the PCR, single-stranded templates and single-stranded PCR products. The integrity of the 3′ end of an oligonucleotide primer used in a primer extension process is critical as it is from this terminus that extension of the nascent strand begins. Degradation of the 3′ end leads to a shortened oligonucleotide which in turn results in a loss of specificity in the priming reaction (i.e., the shorter the primer the more likely it becomes that spurious or non-specific priming will occur).

Still further useful polymerases are thermostable polymerases. For the purposes of some embodiments, a heat resistant enzyme is defined as any enzyme that retains most of its activity after one hour at 40° C. under optimal conditions. Examples of thermostable polymerase which lack both 5′ to 3′ exonuclease and 3′ to 5′ exonuclease include Stoffel fragment of Taq DNA polymerase. This polymerase lacks the 5′ to 3′ exonuclease activity due to genetic manipulation and no 3′ to 5′ activity is present as Taq polymerase is naturally lacking in 3′ to 5′ exonuclease activity. Tth DNA polymerase is derived form Thermus thermophilus, and is available from Epicentre Technologies, Molecular Biology Resource Inc., or Perkin-Elmer Corp. Other useful DNA polymerases which lack 3′ exonuclease activity include a Vent®(exo-), available from New England Biolabs, Inc., (purified from strains of E. coli that carry a DNA polymerase gene from the archaebacterium Thermococcus litoralis), and Hot Tub DNA polymerase derived from Thermus flavus and available from Amersham Corporation.

Other suitable enzymes for the methods disclosed herein are thermostable and deprived of 5′ to 3′ exonuclease activity and of 3′ to 5′ exonuclease activity include AmpliTaq Gold. Other DNA polymerases, which are at least substantially equivalent may be used like other N-terminally truncated Thermus aquaticus (Taq) DNA polymerase I. the polymerase named KlenTaq I and KlenTaq LA are quite suitable for that purpose. Of course, any other polymerase having these characteristics can also be used according to the invention.

Still further, other suitable enzymes for extending the nucleic acid primers are ligases used in combination with as little as a single nucleic acid residue or an oligonucleotide that hybridizes to the template nucleic acid sequence, such as the oligonucleotide tag. DNA ligase catalyzes the ligation of the 3′ end of a DNA fragment to the 5′ end of a directly adjacent DNA fragment. Any number of ligases can be used in the methods disclosed herein. For example, T4 DNA ligase, E. coli DNA ligase, and Taq DNA ligase are commonly used and are well characterized ligases suitable for the methods of the invention disclosed herein.

In some aspects, the invention provides that the detecting step includes nucleic acid sequencing, hybridization or labeling of the amplicon. Such methods for detection are well known in the art, several of which are described herein. Moreover, in one aspect, the invention provides compositions and methods for amplification of the oligonucleotide tag to generate clusters on the solid surface (FIG. 4). Suitable amplification methods include both target amplification and signal amplification. Target amplification involves the amplification (i.e. replication) of the target sequence, i.e. oligonucleotide tag, to be detected, resulting in a significant increase in the number of target molecules. Target amplification strategies include but are not limited to the polymerase chain reaction (PCR) as generally described herein, strand displacement amplification (SDA) as generally described in Walker et al., in Molecular Methods for Virus Detection, Academic Press, Inc., 1995, and U.S. Pat. No. 5,455,166 and U.S. Pat. No. 5,130,238, and nucleic acid sequence based amplification (NASBA) as generally described in U.S. Pat. No. 5,409,818; Sooknanan et al., Nucleic Acid Sequence-Based Amplification, Ch. 12 (pp. 261-285) of Molecular Methods for Virus Detection, Academic Press, 1995; and “Profiting from Gene-based Diagnostics”, CTB International Publishing Inc., N.J., 1996, all of which are incorporated by reference.

Alternatively, rather than amplify the target, alternate techniques use the target as a template to replicate a signaling probe, allowing a small number of target molecules to result in a large number of signaling probes, that then can be detected. Signal amplification strategies include the ligase chain reaction (LCR), cycling probe technology (CPT), invasive cleavage techniques such as Invader™ technology, Q-Beta replicase (QβR) technology, and the use of “amplification probes” such as “branched DNA” that result in multiple label probes binding to a single target sequence.

All of these methods require a primer nucleic acid (including nucleic acid analogs) that is hybridized to a target sequence to form a hybridization complex, and an enzyme is added that in some way modifies the primer to form a modified primer. For example, PCR generally requires two primers, dNTPs and a DNA polymerase; LCR requires two primers that adjacently hybridize to the target sequence and a ligase; CPT requires one cleavable primer and a cleaving enzyme; invasive cleavage requires two primers and a cleavage enzyme; etc.

In one embodiment, a multiplex amplification reaction such a “bridge amplification” is used to amplify the target sequences, i.e. oligonucleotide tag, as described in WO 98/44151, WO 96/04404, WO 07/010251, and U.S. Pat. No. 5,641,658, U.S. Pat. No. 6,060,288, U.S. Pat. No. 6,090,592, U.S. Pat. No. 6,468,751, U.S. Pat. No. 6,300,070, and U.S. Pat. No. 7,115,400, each of which are incorporated herein by reference. Bridge amplification localizes the target and one or more primers within sufficient proximity so that complementary sequences hybridize. Following hybridization, the single stranded regions are extended with, for example, a template directed nucleic acid polymerase to modify each molecule to include the sequence of the extension product. Multiple rounds of this extension procedure will result in the synthesis of a population of amplicons. Because the target nucleic acid and the probe or primer is immobilized at a feature and its adjacent surrounding area, the amplicons become highly localized and concentrated at the area of the discrete feature.

In a further embodiment a single base extension (SBE) reaction can be used to detect an oligonucleotide tag that is hybridized to a solid support. Briefly, SBE utilizes a polymerase to extend the 3′ end of the primer. Based on the fidelity of the enzyme, a nucleotide is only incorporated into the primer if it is complementary to the sequence of interest. SBE can be carried out under any number of known conditions that are suitable for the methods disclosed here. As will be appreciated by those skilled in the art, the configuration of an SBE reaction can take on any of several forms. For example, SBE can be performed on a surface or in solution, wherein the newly synthesized strands can be amplified in a subsequent step.

Moreover, if desired, while using SBE, the nucleotide can be derivatized so that no further extensions can occur. Alternatively, the nucleotide can be derivatized using a blocking group (including reversible blocking groups) so that only a single nucleotide is added. A nucleotide analog useful for SBE can include a dideoxynucleoside-triphosphate (also called deoxynucleotides or ddNTPs, i.e. ddATP, ddTTP, ddCTP and ddGTP), or other nucleotide analogs that are derivatized to be chain-terminating. For example, nucleotides containing cleavable peptide linkers linking a dye and/or blocking groups (removable or not) can be used for SBE. Exemplary analogs are dideoxy-triphosphate nucleotides (ddNTPs) or acyclo terminators. Generally, a set of nucleotides comprising ddATP, ddCTP, ddGTP and ddTTP can be used. As will be appreciated by those skilled in the art, any number of nucleotides or analogs thereof can be added to a primer, as long as a polymerase enzyme is able to incorporate a particular nucleotide.

A nucleotide used in an SBE method can further include a detectable label, such as the ones particularly described herein. The labels can be attached via a variety of linkages. If a primary label is used, the use of secondary labels can also facilitate the removal of unextended probes in particular embodiments.

When SBE is performed, the invention provides an extension enzyme, such as a DNA polymerase. Suitable DNA polymerases include Klenow fragment of DNA polymerase I, Sequenase™ 1.0 and Sequenase™ 2.0 (U.S. Biochemical), T5 DNA polymerase, Phi29 DNA polymerase, and Thermosequenase™ (Taq with the Tabor-Richardson mutation). Modified versions of these polymerases that have improved ability to incorporate a nucleotide analog may be used if so desired. If the nucleotide is complementary to the base of the detection position of the target sequence, which is adjacent to the extension primer, the extension enzyme will add it to the extension primer. Thus, the extension primer is modified, i.e. extended, to form a modified primer.

In some aspects of the invention, a number of sequencing by synthesis reactions can used to elucidate the identity of a oligonucleotide tag. All of these reactions rely on the use of a target sequence, comprising at least two domains; a first domain to which a sequencing primer will hybridize, and an adjacent second domain, for which sequence information is desired. Upon formation of the assay complex, extension enzymes are used to add dNTPs to the sequencing primer, and each addition of dNTP is “read” to determine the identity of the added dNTP. This may proceed for many cycles.

In some aspects of the methods described herein, a nucleic acid, such as an oligonucleotide tag, can have a cleavable linker. Non-limiting examples of cleavable linkers which are useful in the methods include proteins, nucleic acids, polynucleotides, or chemical compounds. In some aspects of the methods, the cleavable linker is photocleavable. A photocleavable linker refers to any chemical group that attaches or operably links a polynucleotide to a solid surface as described herein. Photocleavable linkers that can be useful in the methods include, but are not limited to, 2-nitrobenzyl moieties, alpha-substituted 2-nitrobenzyl moieties [e.g. 1-(2-nitrophenyl)ethyl moieties], 3,5-dimethoxybenzyl moieties, thiohydroxamic acid, 7-nitroindoline moieties, 9-phenylxanthyl moieties, benzoin moieties, hydroxyphenacyl moieties, and NHS-ASA moieties. Photocleavable linkers are well known to those skilled in the art (see U.S. Pat. No. 5,739,386, and U.S. Patent Application Publication 2010-0022761, both of which are herein incorporated by reference). In some aspects, the cleavable linker can be a sequence of nucleotides already present in the polynucleotide itself. For example, the cleavable linker can be the recognition sequence for an endonuclease, such as a restriction endonuclease, nicking endonuclease or homing endonuclease.

As used herein, the term “label” intends a directly or indirectly detectable compound or composition that is conjugated directly or indirectly to the composition to be detected, e.g., polynucleotide or protein such as an antibody so as to generate a “labeled” composition. The term also includes sequences conjugated to the polynucleotide that will provide a signal upon expression of the inserted sequences, such as green fluorescent protein (GFP) and the like. The label may be detectable by itself (e.g. radioisotope labels or fluorescent labels) or, in the case of an enzymatic label, may catalyze chemical alteration of a substrate compound or composition which is detectable. The labels can be suitable for small scale detection or more suitable for high-throughput screening. As such, suitable labels include, but are not limited to radioisotopes, fluorochromes, chemiluminescent compounds, dyes, and proteins, including enzymes. The label may be simply detected or it may be quantified. A response that is simply detected generally comprises a response whose existence merely is confirmed, whereas a response that is quantified generally comprises a response having a quantifiable (e.g., numerically reportable) value such as an intensity, polarization, and/or other property. In luminescence or fluoresecence assays, the detectable response may be generated directly using a luminophore or fluorophore associated with an assay component actually involved in binding, or indirectly using a luminophore or fluorophore associated with another (e.g., reporter or indicator) component.

Examples of luminescent labels that produce signals include, but are not limited to bioluminescence and chemiluminescence. Detectable luminescence response generally comprises a change in, or an occurrence of, a luminescence signal. Suitable methods and luminophores for luminescently labeling assay components are known in the art and described for example in Haugland, Richard P. (1996) Handbook of Fluorescent Probes and Research Chemicals (6th ed.). Examples of luminescent probes include, but are not limited to, aequorin and luciferases.

Examples of suitable fluorescent labels include, but are not limited to, fluorescein, rhodamine, tetramethylrhodamine, eosin, erythrosin, coumarin, methyl-coumarins, pyrene, Malacite green, stilbene, Lucifer Yellow, Cascade Blue™, and Texas Red. Other suitable optical dyes are described in the Haugland, Richard P. (1996) Handbook of Fluorescent Probes and Research Chemicals (6th ed.).

In some embodiments, the invention provides a method for detecting a plurality of target non-nucleic acid analytes in a sample by: providing a plurality of solid supports, wherein each solid support independently includes, a first antibody fragment immobilized to a solid support, wherein the first antibody fragment includes a binding region specific for a first epitope of a unique target non-nucleic acid analyte, a first nucleic acid primer immobilized to the solid support, wherein the first nucleic acid primer includes a nucleic acid sequence that is complementary to a first region of a oligonucleotide tag, and a second nucleic acid primer immobilized to the solid support, wherein the second nucleic acid primer includes a nucleic acid sequence that is the same as a second region of the oligonucleotide tag; providing a plurality of second antibody fragments, wherein each of the second antibody fragments are linked or attached to a distinguishable oligonucleotide tag haivng a first and a second region, and a binding region specific for a second epitope of said unique target non-nucleic acid analyte, wherein the second epitope is distinguishable from the first epitope (see FIG. 1-5); contacting the plurality of solid supports with the plurality of second antibody fragments and a sample include a plurality of unique target non-nucleic acid analytes under sufficient conditions to form a binding complex for each of the plurality of solid supports between: the first antibody fragment and the first epitope of the unique target non-nucleic acid analyte, and the second antibody fragment and the second epitope of the unique target non-nucleic acid analyte, hybridizing the distinguishable oligonucleotide tag to the first nucleic acid primer thereby forming a hybridization complex for each of the plurality of solid supports; extending the first nucleic acid primer for each of the plurality of solid supports whereby a complement of the distinguishable oligonucleotide tag is generated for each of the plurality of solid supports; amplifying the complement of the unique oligonucleotide tag using the second nucleic acid primer for each of the plurality of solid supports thereby forming an amplicon for each of the plurality of solid supports, and detecting the presence of the amplicon for each of the plurality of solid supports, wherein the presence of the amplicon at an individual solid support indicates the presence of the unique target non-nucleic acid analyte in said sample. In some aspects of the invention, the plurality of solid supports are in an array. In a further aspect, the array of solid supports can be a random array or a patterned array.

In some embodiments, the invention provides a method for detecting a plurality of target non-nucleic acid analytes in a sample by: providing a plurality of solid supports, wherein each solid support independently includes, a first antibody fragment immobilized to a solid support, wherein the first antibody fragment includes a binding region specific for a first epitope of a unique target non-nucleic acid analyte, a first nucleic acid primer immobilized to the solid support, wherein the first nucleic acid primer includes a nucleic acid sequence that is complementary to a first region of a oligonucleotide tag, and a second nucleic acid primer immobilized to the solid support, wherein the second nucleic acid primer includes a nucleic acid sequence that is the same as a second region of the oligonucleotide tag; providing a plurality of second antibody fragments, wherein each of the second antibody fragments are linked or attached to a distinguishable oligonucleotide tag having a first and a second region, and a binding region specific for a second epitope of said unique target non-nucleic acid analyte, wherein the second epitope is distinguishable from the first epitope (see FIG. 1-5); contacting the plurality of solid supports with the plurality of second antibody fragments and a sample include a plurality of unique target non-nucleic acid analytes under sufficient conditions to form a binding complex for each of the plurality of solid supports between: the first antibody fragment and the first epitope of the unique target non-nucleic acid analyte, and the second antibody fragment and the second epitope of the unique target non-nucleic acid analyte, hybridizing the distinguishable oligonucleotide tag to the first nucleic acid primer thereby forming a hybridization complex for each of the plurality of solid supports; extending the first nucleic acid primer for each of the plurality of solid supports whereby a complement of the distinguishable oligonucleotide tag is generated for each of the plurality of solid supports; hybridizing the complement of the oligonucleotide tag to the second nucleic acid primer for each of the plurality of solid supports thereby forming a second hybridization complex for each of the plurality of solid supports; extending the second nucleic acid primer with at least one labeled nucleic acid residue for each of the plurality of solid supports, wherein the extension is dependent on the formation of the second hybridization complex, and detecting the presence of the labeled nucleic acid residue for each of the plurality of solid supports, wherein the presence of said labeled nucleic acid residue at an individual solid support indicates the presence of the unique target non-nucleic acid analyte in the sample (see FIGS. 7A and 7B). In some aspects of the invention, the plurality of solid supports are in an array. In a further aspect, the array of solid supports can be a random array or a patterned array.

By “array” or “biochip” herein is meant a plurality of solid supports in an array format; the size of the array will depend on the composition and end use of the array. Nucleic acids arrays are known in the art, and can be classified in a number of ways; both ordered arrays (e.g. the ability to resolve chemistries at discrete sites), and random arrays are included. Ordered arrays include, but are not limited to, those made using photolithography techniques (Affymetrix GeneChip™), spotting techniques (Synteni and others), printing techniques (Hewlett Packard and Rosetta), three dimensional “gel pad” arrays, etc. One embodiment utilizes microspheres on a variety of substrates including fiber optic bundles, as are outlined in PCTs US98/21193, PCT US99/14387 and PCT US98/05025; W098/50782; and U.S. Ser. Nos. 09/287,573, 09/151,877, 09/256,943, 09/316,154, 60/119,323, 091315,584; all of which are expressly incorporated by reference. While much of the discussion below is directed to the use of microsphere arrays on fiber optic bundles, any array format of nucleic acids on solid supports may be utilized.

Arrays containing from about 2 different bioactive agents (e.g. different beads, when beads are used) to many millions can be made, with very large arrays being possible.

Generally, the array will comprise from two to as many as a billion or more, depending on the size of the beads and the substrate, as well as the end use of the array, thus very high density, high density, moderate density, low density and very low density arrays may be made. Suitable ranges for very high density arrays are from about 10,000,000 to about 2,000,000,000, with from about 100,000,000 to about 1,000,000,000 being suitable (all numbers being in square cm). High density arrays range about 100,000 to about 10,000,000, with from about 1,000,000 to about 5,000,000 being particularly suitable. Moderate density arrays range from about 10,000 to about 100,000 being particularly suitable, and from about 20,000 to about 50,000 being especially suitable. Low density arrays are generally less than 10,000, with from about 1,000 to about 5,000 being suitable. Very low density arrays are less than 1,000, with from about 10 to about 1000 being suitable, and from about 100 to about 500 being particularly suitable. In addition, in some arrays, multiple substrates may be used, either of different or identical compositions. Thus for example, large arrays may comprise a plurality of smaller substrates. In some aspects, the invention provides that the plurality of solid supports includes at least 50, 100, 1,000, 10,000, 100,000, 1,000,000, 10,000,000, 100,000,000 or 1,000,000,000 solid supports.

In addition, one advantage of the present compositions is that particularly through the use of fiber optic technology, extremely high density arrays can be made. Thus for example, because beads of 200 μm or less (with beads of 200 nm possible) can be used, and very small fibers are known, it is possible to have as many as 40,000 or more (in some instances, 1 million) different elements (e.g. fibers and beads) in a 1 mm2 fiber optic bundle, with densities of greater than 25,000,000 individual beads and fibers (again, in some. instances as many as 50-100 million) per 0.5 cm2 obtainable (4 million per square cm for 5μ center-to-center and 100 million per square cm for 1μ center-to-center).

Generally, the array of array compositions of the invention can be configured in several ways. In one embodiment, as is more fully outlined below, a one component system is used. That is, a first substrate comprising a plurality of assay locations (sometimes also referred to herein as “assay wells”), such as a microtiter plate, is configured such that each assay location contains an individual array. That is, the assay location and the array location are the same. For example, the plastic material of the microtiter plate can be formed to contain a plurality of “bead wells” in the bottom of each of the assay wells. Beads containing the capture probes of the invention can then be loaded into the bead wells in each assay location as is more fully described below.

Alternatively, a two component system can be used. In this embodiment, the individual arrays are formed on a second substrate, which then can be fitted or “dipped” into the first microtiter plate substrate. One embodiment utilizes fiber optic bundles as the individual arrays, generally with bead wells etched into one surface of each individual fiber, such that the beads containing the capture probes are loaded onto the end of the fiber optic bundle. The composite array thus comprises a number of individual arrays that are configured to fit within the wells of a microtiter plate. A composite array or combination array includes a plurality of individual arrays, as outlined above. Generally the number of individual arrays is set by the size of the microtiter plate used; thus, 96 well, 384 well and 1536 well microtiter plates utilize composite arrays comprising 96, 384 and 1536 individual arrays, although as will be appreciated by those in the art, not each microtiter well need contain an individual array. It should be noted that the composite arrays can comprise individual arrays that are identical, similar or different. That is, in some embodiments, it may be desirable to do the same 2,000 assays on 96 different samples; alternatively, doing 192,000 experiments on the same sample (i.e. the same sample in each of the 96 wells) may be desirable. Alternatively, each row or column of the composite array could be the same, for redundancy/quality control. As will be appreciated by those in the art, there are a variety of ways to configure the system. In addition, the random nature of the arrays may mean that the same population of beads may be added to two different surfaces, resulting in substantially similar but perhaps not identical arrays.

At least one surface of the substrate is modified to contain discrete, individual sites for later association of microspheres. These sites may comprise physically altered sites, i.e. physical configurations such as wells or small depressions in the substrate that can retain the beads, such that a microsphere can rest in the well, or the use of other forces (magnetic or compressive), or chemically altered or active sites, such as chemically functionalized sites, electrostatically altered sites, hydrophobically/hydrophilically functionalized sites, spots of adhesive, etc.

The sites may be a pattern, i.e. a regular design or configuration, or randomly distributed. One embodiment utilizes a regular pattern of sites such that the sites may be addressed in the X-Y coordinate plane. “Pattern” in this sense includes a repeating unit cell, preferably one that allows a high density of beads on the substrate. However, it should be noted that these sites may not be discrete sites. That is, it is possible to use a uniform surface of adhesive or chemical functionalities, for example, that allows the attachment of beads at any position. That is, the surface of the substrate is modified to allow attachment of the microspheres at individual sites, whether or not those sites are contiguous or non-contiguous with other sites. Thus, the surface of the substrate may be modified such that discrete sites are formed that can only have a single associated bead, or alternatively, the surface of the substrate is modified and beads may go down anywhere, but they end up at discrete sites.

In one embodiment, the surface of the substrate is modified to contain wells, i.e. depressions in the surface of the substrate. This may be done as is generally known in the art using a variety of techniques, including, but not limited to, photolithography, stamping techniques, molding techniques and microetching techniques. As will be appreciated by those in the art, the technique used will depend on the composition and shape of the substrate.

In one embodiment, the surface of the substrate is modified to contain chemically modified sites, that can be used to attach, either covalently or non-covalently, the microspheres of the invention to the discrete sites or locations on the substrate. Chemically modified sites in this context includes, but is not limited to, the addition of a pattern of chemical functional groups including amino groups, carboxy groups, oxo groups and thiol groups, that can be used to covalently attach microspheres, which generally also contain corresponding reactive functional groups; the addition of a pattern of adhesive that can be used to bind the microspheres (either by prior chemical functionalization for the addition of the adhesive or direct addition of the adhesive); the addition of a pattern of charged groups (similar to the chemical functionalities) for the electrostatic attachment of the microspheres, i.e. when the microspheres comprise charged groups opposite to the sites; the addition of a pattern of chemical functional groups that renders the sites differentially hydrophobic or hydrophilic, such that the addition of similarly hydrophobic or hydrophilic microspheres under suitable experimental conditions will result in association of the microspheres to the sites on the basis of hydroaffinity. For example, the use of hydrophobic sites with hydrophobic beads, in an aqueous system, drives the association of the beads preferentially onto the sites. As outlined above, “pattern” in this sense includes the use of a uniform treatment of the surface to allow attachment of the beads at discrete sites, as well as treatment of the surface resulting in discrete sites. As will be appreciated by those in the art, this may be accomplished in a variety of ways.

In some embodiments, the methods of the present invention can be used in conjunction with a flow cell. A “flow cell” is a solid phase support that has about eight or more lanes. Each lane can accommodate approximately six million clonally amplified clusters and is designed to present nucleic acids in a manner that facilitates access to enzymes while ensuring high stability of surface-bound templates and low non-specific binding of labeled nucleotides. Indeed, the commercial trend in sequencing instruments appears to be the use of flow cells because of the high throughput analysis that can be achieved with such systems.

In some embodiments, the microspheres may additionally include identifier binding ligands for use in certain decoding systems. By “identifier binding ligands” or “IBLs” herein is meant a compound that will specifically bind a corresponding decoder binding ligand (DBL) to facilitate the elucidation of the identity of the capture probe attached to the bead. That is, the IBL and the corresponding DBL form a binding partner pair. By “specifically bind” herein is meant that the IBL binds its DBL with specificity sufficient to differentiate between the corresponding DBL and other DBLs (that is, DBLs for other IBLs), or other components or contaminants of the system. The binding should be sufficient to remain bound under the conditions of the decoding step, including wash steps to remove non-specific binding. In some embodiments, for example when the IBLs and corresponding DBLs are proteins or nucleic acids, the dissociation constants of the IBL to its DBL will be less than about 10⁻⁴-10⁻⁶ M⁻¹, with less than about 10⁻⁵ to 10⁻⁹ M⁻¹ being suitable for the methods disclosed herein and less than about 10⁻⁷ -10⁻⁹ M⁻¹ being particularly suitable for the methods disclosed herein.

IBL-DBL binding pairs are known or can be readily found using known techniques. For example, when the IBL is a protein, the DBLs include proteins (particularly including antibodies or fragments thereof (FAbs, etc.)) or small molecules, or vice versa (the IBL is an antibody and the DBL is a protein). Metal ion—metal ion ligands or chelators pairs are also useful. Antigen-antibody pairs, enzymes and substrates or inhibitors, other protein-protein interacting pairs, receptor-ligands, complementary nucleic acids, and carbohydrates and their binding partners are also suitable binding pairs. Nucleic acid—nucleic acid binding proteins pairs are also useful. Similarly, as is generally described in U.S. Pat. Nos. 5,270,163, 5,475,096, 5,567,588, 5,595,877, 5,637,459, 5,683,867,5,705,337, and related patents, hereby incorporated by reference, nucleic acid “aptamers” can be developed for binding to virtually any target; such an aptamer-target pair can be used as the IBL-DBL pair. Similarly, there is a wide body of literature relating to the development of binding pairs based on combinatorial chemistry methods.

In one embodiment, the IBL is a molecule whose color or luminescence properties change in the presence of a selectively-binding DBL. For example, the IBL may be a fluorescent pH indicator whose emission intensity changes with pH. Similarly, the IBL may be a fluorescent ion indicator, whose emission properties change with ion concentration.

Alternatively, the IBL is a molecule whose color or luminescence properties change in the presence of various solvents. For example, the IBL may be a fluorescent molecule such as an ethidium salt whose fluorescence intensity increases in hydrophobic environments. Similarly, the IBL may be a derivative of fluorescein whose color changes between aqueous and nonpolar solvents.

In one embodiment, the DBL may be attached to a bead, i.e. a “decoder bead”, that may carry a label such as a fluorophore.

In one embodiment, the IBL-DBL pair comprise substantially complementary single-stranded nucleic acids. In this embodiment, the binding ligands can be referred to as “identifier probes” and “decoder probes”. Generally, the identifier and decoder probes range from about 4 basepairs in length to about 1000, with from about 6 to about 100 being suitable, and from about 8 to about 40 being particularly suitable. What is important is that the probes are long enough to be specific, i.e. to distinguish between different IBL-DBL pairs, yet short enough to allow both a) dissociation, if necessary, under suitable experimental conditions, and b) efficient hybridization.

In one embodiment, as is more fully outlined below, the IBLs do not bind to DBLs. Rather, the IBLs are used as identifier moieties (“IMs”) that are identified directly, for example through the use of mass spectroscopy.

Alternatively, in one embodiment, the IBL and the capture probe are the same moiety; thus, for example, as outlined herein, particularly when no optical signatures are used, the capture probe can serve as both the identifier and the agent. For example, in the case of nucleic acids, the bead-bound probe (which serves as the capture probe) can also bind decoder probes, to identify the sequence of the probe on the bead. Thus, in this embodiment, the DBLs bind to the capture probes.

In one embodiment, the microspheres may contain an optical signature. That is, as outlined in U.S. Ser. Nos. 08/818,199 and 09/151,877, previous work had each subpopulation of microspheres comprising a unique optical signature or optical tag that is used to identify the unique capture probe of that subpopulation of microspheres; that is, decoding utilizes optical properties of the beads such that a bead comprising the unique optical signature may be distinguished from beads at other locations with different optical signatures. Thus the previous work assigned each capture probe a unique optical signature such that any microspheres comprising that capture probe are identifiable on the basis of the signature. These optical signatures comprised dyes, usually chromophores or fluorophores, that were entrapped or attached to the beads themselves. Diversity of optical signatures utilized different fluorochromes, different ratios of mixtures of fluorochromes, and different concentrations (intensities) of fluorochromes.

In one embodiment, the present invention does not rely solely on the use of optical properties to decode the arrays. However, as will be appreciated by those in the art, it is possible in some embodiments to utilize optical signatures as an additional coding method, in conjunction with the present system. Thus, for example, as is more fully outlined below, the size of the array may be effectively increased while using a single set of decoding moieties in several ways, one of which is the use of optical signatures one some beads. Thus, for example, using one “set” of decoding molecules, the use of two populations of beads, one with an optical signature and one without, allows the effective doubling of the array size. The use of multiple optical signatures similarly increases the possible size of the array.

In one embodiment, each subpopulation of beads comprises a plurality of different IBLs. By using a plurality of different IBLs to encode each capture probe, the number of possible unique codes is substantially increased. That is, by using one unique IBL per capture probe, the size of the array will be the number of unique IBLs (assuming no “reuse” occurs, as outlined below). However, by using a plurality of different IBLs per bead, n, the size of the array can be increased to 2, when the presence or absence of each IBL is used as the indicator. For example, the assignment of 10 IBLs per bead generates a 10 bit binary code, where each bit can be designated as “1” (IBL is present) or “0” (IBL is absent). A 10 bit binary code has 210 possible variants However, as is more fully discussed below, the size of the array may be further increased if another parameter is included such as concentration or intensity; thus for example, if two different concentrations of the IBL are used, then the array size increases as 3. Thus, in this embodiment, each individual capture probe in the array is assigned a combination of IBLs, which can be added to the beads prior to the addition of the capture probe, after, or during the synthesis of the capture probe, i.e. simultaneous addition of IBLs and capture probe components.

Alternatively, the combination of different IBLs can be used to elucidate the sequence of the nucleic acid. Thus, for example, using two different IBLs (IBL1 and IBL2), the first position of a nucleic acid can be elucidated: for example, adenosine can be represented by the presence of both IBL1 and IBL2; thymidine can be represented by the presence of IBL1 but not IBL2, cytosine can be represented by the presence of IBL2 but not IBL1, and guanosine can be represented by the absence of both. The second position of the nucleic acid can be done in a similar manner using IBL3 and IBL4; thus, the presence of IBL1, IBL2, IBL3 and IBL4 gives a sequence of AA; IBL1, IBL2, and IBL3 shows the sequence AT; IBL1, IBL3 and IBL4 gives the sequence TA, etc. The third position utilizes IBLS and IBL6, etc. In this way, the use of 20 different identifiers can yield a unique code for every possible 10-mer.

In this way, a sort of “bar code” for each sequence can be constructed; the presence or absence of each distinct IBL will allow the identification of each capture probe.

In addition, the use of different concentrations or densities of IBLs allows a reuse of sorts. If, for example, the bead comprising a first agent has a IX concentration of IBL, and a second bead comprising a second agent has a 10× concentration of IBL, using saturating concentrations of the corresponding labeled DBL allows the user to distinguish between the two beads.

Molecular genetics can be used advantageously to generate desired proteins native to one organism in another organism that would not ordinarily produce such proteins as a way to generate relatively large and efficient yields of such proteins and/or to simplify their purification. Similar principles can be employed to generate recombinant fusion proteins not normally found in nature. Such multi-domain fusion proteins could be valuable because they combine the advantageous properties of two or more different proteins. In one embodiment of this invention, the fusion proteins that are generated contain subunits that are not normally combined within a single protein in nature.

It is often not simple or straightforward to generate ample amounts of a recombinant protein when it is made in a foreign host and/or the protein per se is non-natural. Often times, for example, it is desirable to generate a protein native to higher eukaryotes in a lower eukaryote, or even prokaryote, host. In such instances the protein synthetic machinery might not be adequately designed to generate ample amounts of the desired product. For example, alternate codon usage might have to be employed to optimize use of available tRNAs in the host cells.

In addition to implementing strategies for optimal production of recombinant proteins it is also essential to ensure adequate recovery, and typically purification, of the protein once synthesized. In some cases, for example, it might be desirable to modify the mRNA to add signals to the recombinant proteins such that they will, e.g., be secreted from the host cells that are used for production so that steps will not have to be taken to recover the protein from some intracellular compartment or, in the case of microorganisms, for example, the periplasmic space.

Producing and synthesizing a recombinant fusion protein might be particularly challenging because it might not be readily handled by the protein processing systems within the host. For example, different domains of a recombinant fusion protein might normally be differentially localized so that, e.g., the fusion protein might comprise (a) one or more secreted moieties and one or more intracellular moieties, or (b) one or more cytoplasmic moieties and one or more nuclear moieties, and the like. It is also common that when combined unnaturally, individual domains within fusion proteins might not fold properly, e.g., because of steric hindrance. Alternatively, domains that fold normally within their normal cellular compartment might fold aberrantly when caused to locate to a different compartment by virute of the nature of other domains within a recombinant fusion protein. The upshot of this mismatched situation is often inappropriate folding and concomitant difficulties with purification, activity and/or stability.

This invention also provides the separate production of the individual portions of a fusion protein as subunits and the biochemical tethering of the subunits to generate the desired recombinant proteins. Such separate production allows each portion of the protein to be generated under conditions most amenable to production, folding and purification. After these events had properly occurred for each individual subunit the different subunits would be tethered. As contemplated by this invention the tethering is alternatively through covalent bonds or tight non-covalent binding. Non-limiting examples of both alternatives are provided herein. This approach is particularly useful, as is often the case, when procedures for production and purification of the individual portions of the fusion protein are available but none of such procedures results in generation of adequate amounts of that fusion protein, either because of inadequate levels of biosynthesis, inappropriate folding, ineffective purification, or a combination of the foregoing.

An additional advantage to biochemical tethering is the possibility of more efficiently achieving the functions of the individual components of the moieties of the recombinant fusion protein. As a non-limiting example, the two or more functional components of the recombinant fusion protein are binding domains and once the fusion protein is prepared, one or both domains fail(s) to properly bind its binding partner. Steric hindrance is one possible reason why this problem is encountered. As one enablement in this invention to overcome this problem, one or more of the individual binding components is optionally bound to cognate binding partner(s) prior to tethering with the other component(s) of the recombinant fusion protein.

There are numerous alternatives for biochemically tethering subunits of a desired recombinant fusion protein. One approach is to biochemically tether the subunits by tight non-covalent bonds. Another is to biochemically tether the subject subunits by covalent bonds. Also contemplated in this invention are complex fusion proteins that have more than two subunits. Generation of fusion proteins comprised of more than two portions in a predetermined N-terminal to C-terminal sequence order is achieved in a non-limiting example by the use of more than one pair of tethers. As one such non-limiting example, entities x and X constitute one tether pair and entities y and Y constitute a second tether pair; subunit A contains tether X; subunit B contains two tethers, x and y; and subunit C contains tether Y. In this example, the three subunits are placed into contact with each other under conditions in which the complex recombinant fusion protein A-X:x-B-y:YC is generated. Examples of appropriate tether pairs are provided below.

The tethering process per se can optionally be controlled by manipulating the conditions under which the component subunits of the recombinant fusion protein are brought into contact with each other. As non-limiting examples, a catalyst or an agent that changes ionic strength and/or pH is added to the mixture containing the subunit components only at such time as it is desirable to generate the complete fusion protein. Alternatively, one of the subunits of the desired fusion protein is captured on a solid surface, such as a bead, and the other subunit is added such that the tethers combine to form the fusion protein attached to the desired solid surface. In such a scenario adding excess amounts of the subunit in solution and then washing the solid surface to remove untethered soluble subunit conveniently eliminates one of the unthethered fusion partners.

An advantage of the biochemical tethering strategy is the ability to conveniently and efficiently “mix-and-match” fusion partners. This enablement simplifies the molecular genetics involved in generating the fusion proteins.

In addition, biochemical tethering facilitates production of related members of a recombinant fusion protein family. In one non-limiting example it is desired to generate a family of fusion proteins all of which possess one subunit in common but which differ with respect to a second subunit. As a non-limiting example, it is desired to generate the fusion protein family A-B, A-C, A-O and A-E. Instead of the need to genetically construct each fusion protein separately in this example, the A subunit is constructed with the X entity of a tether pair X:x, to form A-X and each of the second subunits is constructed with the other partner in the tether pair, i.e., x-B, x-C, x-O and x-E. The paired subunits are reacted separately to form the desired constructs A-X:x-B, A-X:x-C, A-X:x-O and A-X:x-E. In a second non-limiting example, both subunits of a recombinant fusion protein are varied, e.g., A-X:x-M, B-X:x-N, A-X:x-N and B-X:x-N. In yet another such example, a family of fusion proteins containing three subunits is constructed with the use of two different tether pairs, X:x and Y:y. In this example the resulting fusion proteins are: A-X:x-M-y:Y-R, A-X:x-N-y-Y-R, A-X:x-M-y:Y-S, A-X:x-N-y:Y-S, B-X:x-M-y:Y-R, B-X:x-N-y-Y-R, B-X:x-M-y:Y-S, B-X:x-N-y:Y-S. In the foregoing example eight family members are generated but it is necessary to prepare and purify only six subunits (A-X, B-X, x-M-y, x-N-y, Y-R and Y-S). Because of the “building-block” nature of these fusion protein constructs, relatively large amounts of the constitutive subunits can be made and stockpiled, thus minimizing the amount of effort required to generate the desired proteins, and creating the ability to efficiently generate new fusion proteins from existing inventory.

In a preferred non-limiting example of the use of the mix-and-match concept of biochemical tethering, it is desired to generate a library of monoclonal antibodies (mAbs) with the ability to act in tandem with each other and to bind to a specific oligonucleotide. In this example, the tether pair x:X is used. A first library of mAbs is made such that every mAb carries an x tether entity and a second library of mAbs is made such that every mAb carries a y tether entity. A plurality of the mAbs from the library is biochemically tethered to an oligonucleotide-binding protein (OBP) carrying an X tether (i.e., X-OBP1). The result is a library of mAbs all of which possess the ability to bind to a particular oligonucleotide, i.e., mAb1:x:X-OBP1, mAb2:x:X-OBP1, mAb3:x:X-OBP1, mAb4:x:X-OBP1, . . . etc. Members of this library would, as a non-limiting example and as considered more fully below, be amenable to array along an oligonucleotide backbone comprising a plurality of oligonucledotide sequences recognized by OBP1. Alternatively, members of this library possess the ability to be captured by a complementary oligonucleotide bound to a solid support.

In yet another preferred enablement of this example of the use of the mix-and-match concept of biochemical tethering, it is desired to generate two libraries of monoclonal antibodies (mAbs) such that mAb members of one library possess the ability to interact in tandem with mAb members of the second library. In this embodiment, the tether pair x:X is used in the construction of both libraries but different OBP's (i.e., OBP1 and OBP2) are tethered to mAbs from the two libraries. Thus a library of mAbs is made such that every mAb carries an x tether entity and two OBPs are constructed such that each OBP carries an X tether (i.e., X-OBP1 and X-OBP2). A first population of mAbs from such mAB library is biochemically tethered to one of the two OBPs (X-OBP1), to generate a first library mAb1:x:X-OBP1, mAb2:x:X-OBP1, mAb3:x:X-OBP1, mAb4:x:X-OBP1, . . . etc. A second population of mAbs from such mAB library is biochemically tethered to the other OBP (X-OBP2) to generate a second library mAb100:x:X-OBP2, mAb101:x:X-OBP2, mAb102:x:X-OBP2, mAb103:x:X-OBP2, . . . etc. mABs from one library thus have the capability of binding to a first cognate oligonculeotide sequence whereas mAbs from the secod library have the capability of binding to a second (different) cognate oligonucleotide sequence. An oligonucleotide backbone comprising one or more of each cognate oligonucleotide sequence is then used to array the mAbs from the two libraries in tandem along the oligonucleotide backbone, as described more fully below.

In still another preferred embodiment of the objective of generating libraries of mABs that can act in tandem with each other, two libraries of monoclonal antibodies (mAbs) and two tether pairs, x:X and y:Y, are used. A first library of mAbs is made such that every mAb carries an x tether entity and a second library of mAbs is made such that every mAb carries a y tether entity. A multiplicity of mAbs from the mAb-x library is then biochemically tethered to an OBP carrying an X tether (i.e., X-OBP1). Similarly, a multiplicity of mAbs from the mAb-y library is then biochemically tethered to an OBP carrying a Y tether (i.e., Y-OBP2) The result is two differentiatable mAb families, mAb1:x:X-OBP1, mAb2:x:X-OBP1, mAb3:x:X-OBP1, mAb4:x:X-OBP1, . . . etc, comprising a first family and mAb100:y:Y-OBP2, mAb101:x:X-OBP2, mAb102:x:X-OBP2, mAb103:x:X-OBP2, . . . etc, comprising a second family. The mAb-OBP fusion proteins are then optionally mixed and matched by using an oligonucleotide containing cognate sequences for OBP1 and/or OBP2.

By ordering the binding sequences along the oligonucleotide in the foregoing examples, the order of mABs bound to that oligonucleotide is optionally determined As a non-limiting example, three tether pairs x:X, y:Y and z:Z are used for generate three different mAb-containing fusion proteins: mAb1:x:X-OBP1, mAb2:y:Y-OBP2, and mAb3:z:Z-OBP3. An oligonucleotide is constructed that includes in a 5′ to 3′ order the binding sites for OBP1, OBP2 and OBP3 with spacer sequences separating the three binding sites. The three mAb-containing fusion proteins are added to the oligonucleotide and the result is an oligonucleotide backbone with mAb1:x:X-OBP1, mAb2:y:Y-OBP2, and mAb3:z:Z-OBP3 arrayed along the backbone in a 5′ to 3′ order.

In summary, one familiar with the art can readily envisage and employ any of a large number of variations of the non-limiting enablements provided above to construct a number of different fusion protein combinations, using different subunits, different numbers of subunits and different tether pairs to generate many different types of fusion proteins and alternatively use such fusion proteins independently or in conjunction with each other.

The biochemical tethering is alternatively achieved via a strong non-covalent binding between the tether pairs or via a covalent interaction between the tether pairs. One non-limiting example of a non covalent tether pair is streptavidin and avitag; avitag is a 17-amino acid peptide that binds to streptavidin with a Kd of 1 Q-14 M. In this example, a first subunit, A, is produced that comprises a scFv domain genetically linked to a streptavidin moiety (step 1). Both of the components in subunit A are typically secreted and thus the subunit is designed to be secreted by the host in which it is produced. A second subunit, B, comprises a methyltransferase domain (variously methyltransferase Hha1 or methyltransferase BamH1) genetically linked to an avitag (B). This subunit is typically cytoplasmic. The subunits are then isolated and combined via the tether pairs (step 2) to form a fusion protein (C), either scFv:streptavidin:avitag:methyltransferase Hha1 and scFv:streptavidin:avitag:methyltransferase BamH1, depending on the identity of subunit B. Each of the two fusion proteins is attached to a DNA molecule containing a dU or SFdC site for binding the methyl transferases that leads to a covalent interaction (step 3), thus forming a fusion protein:DNA backbone complex containing scFv:bamase:barstar:methyltransferase Hha1:DNA (D) or scFv:barnase:barstar:methyltransferase BamH1 (E). These complexes are optionally joined by ligation of the DNA chains to form dimmers, as illustrated in the figure. The ligation reaction is designed to generate either a D-E complex or the reverse E-D complex.

A second non-limiting example of a tight non-covalent tether pair is Barnase and Barstar, the latter being an 89-amino acid peptide and the interaction between the two is also characterized by a Kd of 10-14M. In this example, a first subunit, A, is produced that comprises a scFv domain genetically linked to a bamase tether moiety (Step 1). Both of the components in subunit A are typically secreted and thus the subunit is designed to be secreted by the host in which it is produced. A second subunit, B, comprises a methyltransferase domain (variously methyltransferase Hha1 or methyltransferase BamH1) genetically linked to a barstar tether moiety (Step 2). Both of these components are typically cytoplasmic. The subunits are then isolated and combined via the tether pairs (step 3) to form a fusion protein (C), either scFv:barnase:barstar:methyltransferase Hha1 and scFv:bamase:barstar:methyltransferase BamH1, depending on the identity of subunit B. Each of the two fusion proteins is attached to a DNA molecule containing a dU or SFdC site for binding the methyl transferases that leads to a covalent interaction (step 4), thus forming a fusion protein:DNA backbone complex containing scFv:bamase:barstar:methyltransferase Hha1:DNA (D) or scFv:barnase:barstar:methyltransferase BamH1 (E). These complexes are optionally joined by ligation of the DNA chains to form dimmers, as illustrated in the figure. The ligation reaction is designed to generate either a D-E complex (as shown) or the reverse E-D complex (not sown).

An example of a tether pair that establishes a covalent interaction is that between a serine protease and a serpin, a variety of which are available. A number of additional potential protein and/or peptide pairs can be contemplated by those familiar with the art that can similarly form covalent or tight non-covalent interactions when mixed together under appropriate conditions, and thus be used as tether pairs,.

Once biochemically tethered, recombinant fusion proteins are used in a variety of different ways. As one non-limiting example, a recombinant fusion protein is used to immobilize a target molecule onto a solid surface. In this example a first subunit of the fusion protein contains one member of a tether pair as well as a domain that has an affinity for the solid surface, or to one or more molecules attached to that surface, and a second subunit of the fusion protein contains the other member of the tether pair as well as a domain that binds to the target molecule. The two subunits are brought into contact with each other and form a fusion protein via the tether. The fusion partner is then attached to the solid surface via the binding domain on the first subunit and to the target molecule via the binding domain on the second subunit. As a preferred non-limiting embodiment of this example, the first subunit is an OBP that is bound to its cognate oligonucleotide such that the oligonucleotide has a free single-stranded end and the solid surface contains an oligonucleotide with a single-stranded end that is complementary to the single-stranded sequence at the end of the oligonucleotide bound to the OBP. Any of a large number of OBPs is contemplated for this purpose including OBPs that bind either covalently or in a tight non-covalent fashion. For example, protein TrwC is the conjugative relaxase responsible for DNA processing in plasmid R388 bacterial conjugation. TrwC has two catalytic tyrosines, Y18 and Y26, both able to carry out cleavage reactions using unmodified oligonucleotide substrates. Suicide substrates containing a 30-Sphosphorothiolate linkage at the cleavage site displaced TrwC reaction towards covalent adducts and thereby enabled intermediate steps in relaxase reactions to be investigated. Two distinct covalent TrwC-oligonucleotide complexes could be separated from non covalently bound protein by SDS-PAGE. As observed by mass spectrometry, one complex contained a single, cleaved oligonucleotide bound to Y18, whereas the other contained two cleaved oligonucleotides, bound to Y18 and Y26. Analysis of the cleavage reaction using suicide substrates and Y18F or Y26F mutants showed that efficient Y26 cleavage only occurs after Y18 cleavage. Strand-transfer reactions carried out with the isolated Y18-DNA complex allowed the assignment of specific roles to each tyrosine.

Another example of an OBP that can be used in the invention includes the HaloTag™ (Promega). The HaloTag™ Protein is known to a covalently bound HaloTag™ R Ligand. The HaloTag™ TMR Ligand can covalently bind to the aspartate nucleophile. Replacement of the catalytic base (histidine) with a phenylalanine renders the HaloTag™ Protein inactive by impairing its ability to hydrolyze the ester intermediate, leading to the formation of a stable covalent bond. Moreover, the following Table 3 provides several examples of oligonucleotide-binding proteins suitable for use in fusion proteins.

TABLE 3
Directed Recombinant mAB:DNA Coupling

| Tag | Substrate/ligand | Affinity |
|---|---|---|
| Halo-tag | haloalkane* | covalent |
| Snap-tag | benzylguanine* | covalent |
| Cutinase | phosphonate* | covalent |
| DNA methylase | dU or 5FdC* | covalent |
| trwC | phosphothioate | covalent |
| Streptavidin | biotin | 10⁻¹⁴ |
| mutEcoRI | DNA | 10⁻¹³ |
| Tus | DNA | 10⁻¹³ |
| Rap | DNA | 10⁻¹⁸ |
| LacI | DNA | 10⁻¹¹ |

*mechanism-based “suicide inhibitors”

The second subunit is a mAb that binds to a target molecule. Following construction of the recombinant fusion protein, in a first enablement the first subunit is anchored the solid surface via oligonucleotide hybridization and is then used to capture the target molecule via the mAb on the second subunit. In a second enablement the second subunit is first used to capture the target molecule via the mAb in solution and then is subsequently anchored to the solid surface via hybridization of the single-stranded oligonucleotides bound to the first subunit and to the solid surface.

In a further embodiment the first subunit is an OBP bound to its cognate oligonucleotide and the second subunit is an enzyme, the two subunits being attached by a biochemical tether and wherein the resulting fusion protein is bound to a solid surface via hybridization between the oligonucleotide bound to the fusion protein and a complementary oligonucleotide bound to the solid surface. As a non-limiting embodiment of this example, the solid surface is a bead and a multiplicity of fusion proteins are attached to the bead, resulting in a bead carrying a multiplicity of enzyme molecules. In a related embodiment there are two or more different types of fusion proteins in which the OBP subunit is the same but the enzyme subunit is different, thus resulting in a multiplicity of different enzymes attached to the same bead.

In yet another related embodiment there are two or more fusion proteins, each differing with respect to both a first and a second subunit such that the first subunit in fusion protein A comprises an OBP that recognizes an oligonucleotide a and the first subunit in fusion protein B comprises an OBP that recognizes an oligonucleotide b, and the like, and whereas the second subunit in fusion protein A comprises an enzyme that generates a product that is metabolized by the enzyme that comprises the second subunit of fusion protein B, and the like. In this embodiment the two fusion proteins are optionally linked by an oligonucleotide comprising a sequence a that is 5′ to a sequence b with an intervening sequence between the two sequences a and b, such that the two fusion proteins are bound to the oligonucleotide in the order 5′end-A-B-3′ end. Even more complex chains of fusion proteins are constructed in related embodiments by ligating together pre-formed fusion protein-oligonucleotide complexes. In one such non-limiting example, fusion protein A is bound via an OBP subunit to oligonucleotide a, fusion protein B is bound via an OBP subunit to oligonucleotide b, fusion protein C is bound via an OBP subunit to oligonucleotide c and fusion protein D is bound via an OBP subunit to oligonucleotide d. The oligonucleotide moieties are then ligated together by any of several methods well known in the art to generate a complex containing fusion proteins A, B, C and D arrayed in 5′ to 3′ order along the ligated oligonucleotide.

Another non-limiting example of the use of biochemically tethered fusion proteins is to enable quantitation. As one variation of this function, a first subunit, which is capable of binding a target, is tethered to a second subunit that can be measured by any of a number of means well known in the art, including, as non-limiting examples a fluorescent signal, an enzyme activity or an oligonucleotide sequence that can be measured, optionally following amplification, said measurement serving as a means of quantitating the amount of bound target.

As a non-limiting example of quantitation by fluorescence measurement, a second subunit comprising green fluorescent protein is bound via a biochemical tether to a first subunit that binds a target. Fusion protein bound to target is captured separately from fusion protein not bound to target by any of a number of means well known in the art and the amount of target is determined by fluorescent detection of the green fluorescent protein, optionally by comparison to a standard curve of fluorescence vs concentration of green fluorescence protein.

As a non-limiting example of quantitation by enzyme activity, a second subunit comprising alkaline phosphatase is bound via a biochemical tether to a first subunit that binds a target. Fusion protein bound to target is captured separately from fusion protein not bound to target by any of a number of means well known in the art and the amount of target is determined by determination of alkaline phosphatase activity, optionally by comparison to a standard curve of alkaline phosphatase activity vs concentration of alkaline phosphatase protein.

As a non-limiting example of quantitation by measurement of an oligonucleotide sequence, a second subunit comprising an OSP bound to an oligonucleotide comprising a known single strand sequence is bound via a biochemical tether to a first subunit that binds a target. Fusion protein bound to target is captured separately from fusion protein not bound to target by any of a number of means well known in the art and the amount of target is determined by measurement of the concentration of bound oligonucleotide, optionally facilitated by amplification of the oligonucleotide by the polymerase chain reaction (PCR) or any other amplification method known in the art, prior to such measurement.

In an alternate enablement, complexes are prepared so as to carry out a combination of functions. In one non-limiting example, a fusion protein comprises a first subunit containing a binding site for a target molecule bound via a biochemical tether to a second subunit comprising an OSP and its cognate oligonucleotide, such oligonucleotide comprising two single-stranded regions, one of which hybridizes with a complementary sequence bound to a solid support and the second of which is used for quantitation via an amplification process such as PCR. In this way, the complexes permit quantitation of the amount of binding of a target molecule to a solid support. Optionally in this enablement, a plurality of such recombinant fusion proteins is linked via the oligonculeotide such that more than one fusion protein is bound to the target molecule, thus increasing the affinity of the binding and, in instances in which the plurality of fusion proteins are bound to different epitopes of the target molecule, increasing both the affinity and the specificity of the binding.

In yet another enablement, complexes are prepared so as to carry out a different combination of functions. In this non-limiting example, a fusion protein is prepared, each comprising a first subunit containing an enzyme bound via a biochemical tether to a second subunit comprising an OSP and its cognate oligonucleotide, such oligonucleotide comprising a single-stranded region that hybridizes with a complementary sequence bound to a bead. The fusion proteins are attached to the beads and a substrate for the enzyme is added. The result is an enhanced enzymatic reaction enabled by the concentration of enzyme on the bead. In one variation of this enablement, fusion proteins each containing a different enzyme are attached to a bead such that the plurality of enzymes attached to a bead establish a metabolic pathway, and thus the product of a first enzyme reaction serves as a substrate for a second enzyme reaction, and so forth, the result being an optimized metabolic process enabled by the close proximity of the enzymes in the pathway. In a related non-limiting enablement, a plurality of such fusion proteins, each with a different enzyme in a metabolic pathway, are ordered and arrayed along an oligonucleotide backbone such that the product of a first enzyme, once generated, is in proximity to the next enzyme in the pathway, thus optimizing the efficiency of the metabolic process. For example, the tus protein can be used as the OBP (Gottlieb et al., 1992; Mulugu et al., 2001). The rod attached to the OBP comprises a cognate “ter” DNA sequence (Gottlieb et al., 1992; Mulugu et al., 2001). T4 DNA ligase requires dsDNA with at least one 5′ phosphate adjacent to a 3′ hydroxyl group. Ligating a dsDNA having only a single phosphate and adjacent hydroxyl will create a nicked molecule. The fusion gene products can be ligated in a defined fashion using ends of DNA with defined sequences, and T4 DNA ligase. DNA can be considered a ‘stiff rod.’ The rod can be further stiffened using modified nucleotides. For example, the locked nucleotides (LNAs). A nick, or single break in the backbone allows the molecule to rotate around the other strand. The nick can be created by ligation of only a single phosphate of the dsDNA or by using a nickase enzyme to cleave one side of a DNA recognition site. Nickase enzymes are similar to restriction enzymes except that they recognize an asymmetric DNA sequence and nick one (but not both) strands of the DNA. New England Biolabs (Beverly, Mass.) sells several nicking endonucleases, including; Nb.BbvCI, Nb.Bsml, Nb.BsrDI, Nb.Btsl, Nt.Alwl, Nt.BbvCI, Nt.BspQI, Nt.BstNBI, Nt.CviPII. The complex, once formed, may optionally be attached to a solid surface such as a bead by any of a number of ways including by having the DNA backbone have a single-stranded terminus that has a sequence complementary to a single-stranded oligonucleotide attached to the solid surface. This example also demonstartes how manipulation of the backbone may optionally be implemented to increase its flexibility and thereby to optimize functional effectiveness of the complex.

One non-limiting way to generate and confirm the structure of the complex includes the following: sets of oligonucleotides containing terB binding sites, 5′ phosphates, 3′ hydroxyls and asymmetric ends are bound to tus subunits, which are in turn bound to an enzyme via a fusion pair; ligation of the different asymmetric ends using T4 DNA ligase enables precise control of the order of the enzymes in the formed polymers; and after ligation, either PAGE gel analysis or qPCR using TaqMan probes F and R is used to quantify the amount of full-length oligonucleotide product formed. Sequence analysis of the PCR product is used to validate the correct order of the fragments.

Patent Application PCT/US08/77887 (Polynucleotide Backbones for Complexing Proteins, Weiner and Sherman) describes a number of ways in which recombinant proteins, each possessing an OBP domain, may optionally be complexed along a DNA backbone and describes multiple uses for such complexes. The tethered fusion proteins containing an OBP subunit that are one subject of the present invention may optionally be complexed and used in the same way as described in that patent application. One non-limiting example described in that application generates light by a coupled reaction of the enzymes sulfurylase and luciferase. In the present invention, the same objective is achieved by virtue of having one of the subunits of a first fusion protein comprising sulfurylase and one of the subunits of a second fusion protein comprising luciferase. Other methods of complexing and using such complexes would be readily evident to those familiar with the art.

By analogy with building structures with children's construction kits, the ability to quickly assemble and test various fusion proteins using tethered sets and then to combine these proteins in different configurations will have significant implications across a wide varieties of fields, including, but not limited to, diagnostics, biofuels and pharmaceutical syntheses.

This invention describes approaches for the convenient production of new types of proteins that have new functions, new combinations of functions or improved functions compared with naturally occurring proteins functions, by the use of tether pairs to join two or more functional subunits together. We believe it has significant applications in several areas of interest, including, but not limited to: i) diagnostics; ii) proteomic characterization via high-complexity protein detection, capture and quantitation; iii) alternative energy-efficient separation techniques including membranes, adsorption and alternatives to distillation; iv) bioenergy technologies, including, biomass conversion, biorefinery innovation and integration, novel methods such as novel marine, plant, algal and microbial bioenergy sources, hydrogen production and methods for distributed bioenergy production; v) metabolic engineering for production of co-products into biomass crops of interests; vi) innovative methods to improve cell culture technology (e.g., more effective fermentation process development); vii) genomics and proteomic characterization to understand efficiency of biofuel synthesis; vi) carbohydrate research for improved production of biofuels, including cellulosic ethanol; vii) enzyme technology; viii) recombinant DNA technology; ix) metabolic engineering; and x) high throughput screening tools for optimizing and modeling the manufacturing conditions of biopharmaceuticals and tissue-engineered products.

This invention provides a method for tethering two or more polypeptide subunits to generate a multifunctional fusion protein. In one enablement, one or more of the subunits of the fusion protein carries out a primary function, e.g., binding a target protein or enzymatic activity, and one or more of the subunits of the fusion protein carries out a secondary function, e.g., capture on a solid matrix or quantitation. In a second enablement the subunits of the fusion protein carry out a single function jointly, e.g., capture of a molecule by a binding domain on one subunit and alteration of the molecule by a catalytic domain on a second subunit. Optionally, these fusion proteins are combined, forming a complex to achieve or optimize a primary function, e.g., tighter and/or more specific binding of a target molecule or improved enzyme efficiency. Similarly, these fusion proteins are optionally complexed to achieve, optimize and/or combine secondary functions, e.g., capture of a complex on a solid matrix and quantitation of the amount of complex bound. Alternatively, these fusion proteins are optionally complexed to achieve, optimize and/or combine a single function jointly, e.g., establishment of an linked metabolic pathway involving a plurality of enzymatic steps for efficient conversion of a starting substrate to a desired metabolic product.

Coupling means are disclosed to enable the formation of the protein fusions and, optionally, to facilitate their combination for form multi-protein complexes. Such fusion protein complexes can be ordered to act in unison with improved efficiencies. For example, certain embodiments of this invention contemplate the ordered assembly of two or more fusion proteins into polymers with increased enzymatic activity. By combining tethered fusion proteins containing enzymes in a metabolic pathway in a manner that places the product of one enzyme reaction adjacent to the next enzyme in a metabolic pathway, it is possible to mimic substrate channeling and thereby generate more efficient bioprocesses. By keeping the enzymes both in solution and distal to a substratum, the enzymes remain active for extended periods.

Other embodiments of this invention contemplate the ordered assembly of two or more fusion proteins into complexes with increased binding activity. By combining tethered fusion proteins containing binding domains directed to different epitopes of a single molecular target, it is possible to increase both the affinity and specificity with which the target molecule is captured. By keeping the binding domains either in solution or distal to a bound substratum, it is possible to capture the target molecule while minimizing surface effects.

The present invention provides a novel approach for the defined tethering of molecules and macromolecules including enzymes and/or affinity binders, including antibodies and single chain antibodies, as well as non-enzyme or non-affinity binder moieties. In this invention, these complexes, once prepared, are optionally attached to a solid surface, in a non-limiting example a bead.

In alternative aspects of this invention, the complexes are constituted of proteins other than enzymes or even non-protein moieties. For example, in efforts to generate optimally functional molecules it is sometimes desirable to generate a complex molecule with proteinaceous and non-proteinaceous portions. One such non-limiting example described in detail in this invention is a complex between a fusion protein containing tethered subunits wherein one or more of the subunits binds an oligonucleotide. Another non-limiting example is the use of biochemical tethering to form a fusion molecule in which one or more portion is polypeptide in nature and a second portion is not polypeptide in nature, one such example being a fusion molecule in which an enzyme is biochemically tethered to a co-factor.

In yet another aspect of this invention the complex is attached to a substrate; in various non-limiting enablements the substrate is, alternatively, a bead, the surface of a multiwall plate or a non-bead column chromatography matrix. The foregoing non-limiting alternatives provide considerable flexibility in the design of sUbstrate:complex combinations, requiring only a suitable attachment chemistry between the two, such chemistries being well known in the art.

In yet another embodiment of this invention the complex is suspended and used in a solution.

This invention can be further applied to microfluidics instrumentation.

The invention has further utility by the combined use of automation, genetics, microfluidics, data analysis and the HT cloning and protein production. Such integration permits expansion of the amount and types of tethered fusion proteins and complexes of fusion proteins that can be generated and ways in which they can be used.

### REFERENCES

Ausubel et al. (eds.) Current protocols in molecular biology, John Wiley & Sons, 1992

Cull, M. G., and P. J. Schatz (2000) Biotinylation of proteins in vivo and in vitro using small peptide tags. Methods Enzymol. 326:430-440.

de Wet J R, Wood K V, Helinski D R, Deluca M. Cloning of firefly luciferase cDNA and the expression of active luciferase in Escherichia coli. Proc Natl Acad Sci USA. 1985 82(23):7870-3.

de Wet, et al., 1987. Firefly luciferase gene: structure and expression in mammalian cells. Mol. Cell. BioI. 7: 725-7373

Gottlieb P A, Wu S, Zhang X, Tecklenburg M, Kuempel P, Hill T M. Equilibrium, kinetic, and footprinting studies of the Tus-Ter protein-DNA interaction. J Bioi Chem. Apr. 15,1992; 267(11):7434-43.

Hawes and Nicholas, 1973. Adenosine 5′-triphosphate sulphurylase from Saccharomyces cerevisiae. Biochem. J. 133: 541-550

Huang X, Holden H M, Raushel F M (2001). Channeling of substrates and intermediates in enzyme-catalyzed reactions“. Annu. Rev. Biochem. 70: 149-80.

Jha, et al., 1990. Simultaneous synthesis of enzymatically active luciferase and biologically active beta subunit of human chorionic gonadotropin in caterpillars infected with a recombinant baculovirus. FEBS lett. 274: 24-26

Keller, et al., 1987. Firefly luciferase is targeted to peroxisomes in mammalian cells. Proc. Natl. Acad. Sci. USA 82: 3264-326.

Leach, 1981. J. Appl. Biochem. 3: 473-517

Lundin, 1982. Applications of firefly luciferase In; luminescent Assays (Raven Press, New York)

McElroy and Selinger, 1960. Spectral emission and quantum yield of firefly bioluminescence. Arch. Biochem. Biophys. 88: 136-145

Miles E W, Rhee S, Davies D R (April 1999). “The molecular basis of substrate channeling”. J. BioI. Chem. 274 (18): 12193-6.

Ow, et al., 1986. Transient and Stable Expression of the Firefly luciferase Gene in Plant Cells and Transgenic Plants. Science 234: 856-859

Perham R N (2000). “Swinging arms and swinging domains in multifunctional enzymes: catalytic machines for multistep reactions”. Annu. Rev. Biochem. 69: 961-1004.

Rusmini, Zhong and Feijen. (2007) Protein immobilization strategies for protein biochips. Biomacromolecules 8:1775-1789.

S. Mulugu, A. Potnis, Shamsuzzaman, J. Taylor, K. Alexander, and D. Bastia (2001) Mechanism of termination of DNA replication of Escherichia coli involves helicase-contrahelicase interaction. Proc. Natl. Acad. Sci. USA, 98(17): 9569-9574.

Seubert, et al., 1983. ATP sulfurylase from Penicillium chrysogenum: measurements of the true specific activity of an enzyme subject to potent product inhibition and a reassessment of the kinetic mechanism. Arch. Biochem. Biophys. 225: 679-691;

Seubert, et al., 1985. Adenosinetriphosphate sulfurylase from Penicillium chrysogenum: steady-state kinetics of the forward and reverse reactions, alternative substrate kinetics, and equilibrium binding studies. Arch. Biochem. Biophys. 240: 509-523

Throughout this application various publications have been referenced. The disclosures of these publications in their entireties are hereby incorporated by reference in this application in order to more fully describe the state of the art to which this invention pertains. Although the invention has been described with reference to the examples provided above, it should be understood that various modifications can be made without departing from the spirit of the invention.

What is claimed is:

1. A method for detecting a plurality of target non-nucleic acid analytes in a sample comprising:
(a) providing a plurality of solid supports, wherein each solid support independently comprises,
(i) a first antibody fragment immobilized to a solid support, wherein said first antibody fragment comprises a binding region specific for a first epitope of a unique target non-nucleic acid analyte,
(ii) a first nucleic acid primer immobilized to said solid support, wherein said first nucleic acid primer comprises a nucleic acid sequence that is complementary to a first region of a oligonucleotide tag, and
(iii) a second nucleic acid primer immobilized to said solid support, wherein said second nucleic acid primer comprises a nucleic acid sequence that is the same as a second region of said oligonucleotide tag;
(b) providing a plurality of second antibody fragments, wherein each of said second antibody fragments is attached to a distinguishable oligonucleotide tag comprising a first and a second region, and a binding region specific for a second epitope of said unique target non-nucleic acid analyte, wherein said second epitope is distinguishable from said first epitope;
(c) contacting said plurality of solid supports with said plurality of second antibody fragments and a sample comprising a plurality of unique target non-nucleic acid analytes under sufficient conditions to form a binding complex for each of the plurality of solid supports between:
(i) said first antibody fragment and said first epitope of said unique target non-nucleic acid analyte, and
(ii) said second antibody fragment and said second epitope of said unique target non-nucleic acid analyte,
(d) hybridizing said distinguishable oligonucleotide tag to said first nucleic acid primer thereby forming a hybridization complex for each of the plurality of solid supports;
(e) extending said first nucleic acid primer for each of the plurality of solid supports whereby a complement of said distinguishable oligonucleotide tag is generated for each of the plurality of solid supports;
(f) amplifying said complement of said unique oligonucleotide tag using said second nucleic acid primer for each of the plurality of solid supports thereby forming an amplicon for each of the plurality of solid supports, and
(g) detecting the presence of said amplicon for each of the plurality of solid supports,
wherein the presence of said amplicon at an individual solid support indicates the presence of said unique target non-nucleic acid analyte in said sample.

2. The method of claim 1, wherein said detecting step comprises nucleic acid sequencing, hybridization or labeling of said amplicon.

3. The method of claim 1, wherein said plurality of solid supports are beads.

4. The method of claim 1, wherein said first and second antibody fragments are selected from the group consisting of a Fd, a Fv, a Fab, a F(ab′), a F(ab)₂, a F(ab′)₂, a single chain Fv (scFv), a diabody, a triabody, a tetrabody and minibody.

5. The method of claim 1, wherein said first antibody fragment, said first nucleic acid primer or said second nucleic acid primer are immobilized to said solid support through a covalent bond.

6. The method of claim 1, wherein said first antibody fragment further comprises a nucleic acid capture sequence.

7. The method of claim 1, wherein said first nucleic acid primer is no more than 20, 30, 40, 50, 60, 70, 80, 90 or 100 residues in length.

8. The method of claim 1, wherein said second nucleic acid primer is no more than 20, 30, 40, 50, 60, 70, 80, 90 or 100 residues in length.

9. The method of claim 1, wherein said oligonucleotide tag is no more than 50, 100, 150, 200, 300, 400 or 500 residues in length.

10. A method for detecting a plurality of target non-nucleic acid analytes in a sample comprising:
(a) providing a plurality of solid supports, wherein each solid support independently comprises,
(i) a first antibody fragment immobilized to a solid support, wherein said first antibody fragment comprises a binding region specific for a first epitope of a unique target non-nucleic acid analyte,
(ii) a first nucleic acid primer immobilized to said solid support, wherein said first nucleic acid primer comprises a nucleic acid sequence that is complementary to a first region of a oligonucleotide tag, and
(iii) a second nucleic acid primer immobilized to said solid support, wherein said second nucleic acid primer comprises a nucleic acid sequence that is the same as a second region of said oligonucleotide tag;
(b) providing a plurality of second antibody fragments, wherein each of said second antibody fragments is attached to a distinguishable oligonucleotide tag comprising a first and a second region, and a binding region specific for a second epitope of said unique target non-nucleic acid analyte, wherein said second epitope is distinguishable from said first epitope;
(c) contacting said plurality of solid supports with said plurality of second antibody fragments and a sample comprising a plurality of unique target non-nucleic acid analytes under sufficient conditions to form a binding complex for each of the plurality of solid supports between:
(i) said first antibody fragment and said first epitope of said unique target non-nucleic acid analyte, and
(ii) said second antibody fragment and said second epitope of said unique target non-nucleic acid analyte,
(d) hybridizing said distinguishable oligonucleotide tag to said first nucleic acid primer thereby forming a hybridization complex for each of the plurality of solid supports;
(e) extending said first nucleic acid primer for each of the plurality of solid supports whereby a complement of said distinguishable oligonucleotide tag is generated for each of the plurality of solid supports;
(f) hybridizing said complement of said oligonucleotide tag to said second nucleic acid primer for each of the plurality of solid supports thereby forming a second hybridization complex for each of the plurality of solid supports;
(g) extending said second nucleic acid primer with at least one labeled nucleic acid residue for each of the plurality of solid supports, wherein said extension is dependent on the formation of said second hybridization complex, and
(h) detecting the presence of said labeled nucleic acid residue for each of the plurality of solid supports,
wherein the presence of said labeled nucleic acid residue at an individual solid support indicates the presence of said unique target non-nucleic acid analyte in said sample.

11. The method of claim 10, wherein following the extension of said first nucleic acid primer in step (e), said second antibody fragment comprising said oligonucleotide tag is removed from said solid support.

12. The method of claim 11 wherein said extension in step (g) comprises a polymerase or a ligase.

13. The method of claim 12 wherein said extension in step (g) comprises single base extension or sequencing by synthesis.

14. The method of claim 10, wherein said plurality of solid supports are beads.

15. The method of claim 10, wherein said first and second antibody fragments are selected from the group consisting of a Fd, a Fv, a Fab, a F(ab′), a F(ab)₂, a F(ab′)₂, a single chain Fv (scFv), a diabody, a triabody, a tetrabody and minibody.

16. The method of claim 10, wherein said first antibody fragment, said first nucleic acid primer or said second nucleic acid primer are immobilized to said solid support through a covalent bond.

17. The method of claim 10, wherein said first antibody fragment further comprises a nucleic acid capture sequence.

18. The method of claim 17, wherein said first antibody fragment is immobilized to said solid support by hybridization of said nucleic acid capture sequence to a capture probe immobilized to said solid support.

19. The method of claim 10, wherein said first nucleic acid primer is no more than 20, 30, 40, 50, 60, 70, 80, 90 or 100 residues in length.

20. The method of claim 10, wherein said second nucleic acid primer is no more than 20, 30, 40, 50, 60, 70, 80, 90 or 100 residues in length.

21. The method of claim 10, wherein said oligonucleotide tag is no more than 50, 100, 150, 200, 300, 400 or 500 residues in length.

22. The method of claim 10, wherein the affinity of said binding complexes between said first antibody fragment and said first epitope of said target non-nucleic acid analyte, and said second antibody fragment and said second epitope of said target non-nucleic acid analyte are each independently greater than the affinity of said first hybridization complex formed between said oligonucleotide tag and said first nucleic acid primer.

23. The method of claim 22, wherein said method further comprising removing second antibody fragments that are not immobilized to said solid support through said binding complex from said solid support.

24. The method of claim 23, wherein said removing step comprises heating or washing said solid support.

25. The method of claim 22, wherein said plurality of second antibody fragments further comprises a cleavable linker between said antibody fragment and said distinguishable oligonucleotide tag.

26. The method of claim 25, wherein said cleavable linker is cleaved following formation of said first hybridization complex and said first antibody fragment, second antibody fragment and said unique target non-nucleic acid analyte are removed from said solid support.

27. The method of claim 10, wherein each distinguishable oligonucleotide tag comprises an analyte identifying sequence.

28. The method of claim 10, wherein said extension in step (e) comprises a polymerase or a ligase.

29. The method of claim 10, wherein said plurality of solid supports comprises at least 50, 100, 1,000, 10,000, 100,000, 1,000,000, 10,000,000, 100,000,000 or 1,000,000,000 solid supports.

30. The method of claim 10, wherein said plurality of solid supports are in an array.

31. The method of claim 30, wherein said array is a random array.

32. An array comprising a plurality of solid supports, wherein each solid support independently comprises:
(a) a first antibody fragment immobilized to a solid support, wherein said first antibody fragment comprises a binding region specific for a first epitope of a unique target non-nucleic acid analyte;
(b) a second antibody fragment attached to a distinguishable oligonucleotide tag comprising a first and a second region, and a binding region specific for a second epitope of said unique target non-nucleic acid analyte, wherein said second epitope is distinguishable from said first epitope;
(c) a first nucleic acid primer immobilized to said solid support, wherein said first nucleic acid primer comprises a nucleic acid sequence that is complementary to said first region of said oligonucleotide tag, and
(d) a second nucleic acid primer immobilized to said solid support, wherein said second nucleic acid primer comprises a nucleic acid sequence that is the same as said second region of said oligonucleotide tag,
(e) a binding complex between:
(i) said first antibody fragment and said first epitope of said unique target non-nucleic acid analyte, and
(ii) said second antibody fragment and said second epitope of said unique target non-nucleic acid analyte, and
(f) a hybridization complex between:
(i) said distinguishable oligonucleotide tag and
(ii) said first nucleic acid primer.
